(19) United States
(12) Patent Application Publication
(10) Pub. No.: US 2026/0288845 A1
(43) Pub. Date: Sep. 24, 2026

(54) SYSTEM

(71) Applicant: SoftBank Group Corp., Tokyo (JP)

(72) Inventor: Koji YOKOYAMA, Tokyo (JP)

(73) Assignee: SoftBank Group Corp., Tokyo (JP)

(21) Appl. No.: 19/567,009

(22) Filed: Mar. 14, 2026

(30) Foreign Application Priority Data
Mar. 19, 2025 (JP) 2025-045094

(51) Int. Cl. G06F 16/34; G06F 40/253; G06F 40/35; G06N 3/0455; G10L 25/63

(52) U.S. Cl. CPC G06F 16/345; G06F 40/253; G06F 40/35; G06N 3/0455; G10L 25/63

(57) ABSTRACT

A system includes a processor that is configured to convert audio data into character data, correct the character data grammatically and semantically by using a natural language processing technique, and generate a summary of corrected character data by inputting a prompt, for instructing generation of the summary, into a generative AI model to generate the summary.

### CROSS-REFERENCE TO RELATED APPLICATION

This application is based on and claims priority under 35 USC 119 from Japanese Patent Application No. 2025-045094 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In online meetings and other spoken communication environments, it is often necessary to generate accurate written records and concise summaries of discussions. Conventional systems that simply convert audio data into text by speech recognition frequently produce transcripts that contain grammatical errors, semantic inconsistencies, and misrecognitions, making the transcripts difficult to read and unreliable as official records.

Furthermore, known systems generally do not provide a mechanism to systematically leverage advanced natural language processing and generative AI models in a coordinated manner. As a result, the quality of the corrected text and generated summaries is limited, and important nuances of the conversation may be lost.

In addition, conventional transcription and summarization tools rarely consider emotional information present in the audio data. Emotional states of speakers, such as frustration, satisfaction, or urgency, are important indicators for understanding the true status and progress of a meeting. However, many existing systems do not analyze acoustic characteristics and linguistic content to recognize emotions, nor do they evaluate the progress of a meeting based on such recognized emotions. Consequently, meeting organizers and participants lack objective, AI-assisted insight into how the meeting is proceeding from an emotional or engagement perspective.

Therefore, there is a need for a system that not only converts audio data into text, but also performs grammatical and semantic correction using natural language processing techniques, generates high-quality summaries using generative AI models, and additionally recognizes emotions from the audio data and evaluates the progress of a meeting based on the recognized emotions.

### SUMMARY

In order to solve the above-described problems, according to one aspect of the present invention, there is provided a system comprising a processor, wherein the processor is configured to convert audio data into character data. By converting the spoken content of participants in an online meeting or other audio source into character data, the system provides a basis for subsequent natural language processing and analysis.

The processor is further configured to correct the character data grammatically and semantically by using a natural language processing technique. For example, the processor may apply a deep learning based language model, such as a transformer model, to correct misrecognized words, improve grammatical structure, and adjust expressions to be semantically coherent. Through this correction, the system produces a readable and reliable transcript that can serve as an accurate record of the meeting.

In addition, the processor is configured to generate a summary of corrected character data by inputting a prompt, for instructing generation of the summary, into a generative AI model to generate the summary. In one embodiment, the processor generates a prompt that includes instructions such as extracting main discussion points, decisions, and action items, and supplies this prompt together with the corrected character data to a generative AI model. The generative AI model, in response to the prompt, outputs a concise and coherent summary of the meeting content, thereby reducing the burden on users to manually review lengthy transcripts.

In a preferred embodiment, the processor is configured to analyze acoustic characteristics and linguistic content of the audio data to recognize an emotion. The processor may analyze features such as pitch, intensity, speech rate, and prosody, in combination with lexical and syntactic features of the recognized text, in order to classify emotional states such as neutrality, satisfaction, anger, or frustration. By recognizing emotions, the system enriches the transcription and summarization with additional contextual information regarding the emotional tone of the meeting.

Furthermore, the processor is configured to evaluate a progress of a meeting based on the recognized emotion. For example, the processor may determine whether the meeting is proceeding smoothly, facing conflict, or reaching consensus by aggregating emotional indicators over time and across speakers. The processor may generate indicators or reports that show how the emotional state of the meeting evolves, enabling the user to understand not only what was discussed, but also how participants responded emotionally during the meeting.

Through these configurations, the system according to the present invention provides an integrated solution that converts audio data to text, corrects the resulting text both grammatically and semantically, generates high-quality summaries using generative AI models, and additionally recognizes emotions and evaluates meeting progress based on these recognized emotions, thereby effectively solving the above-mentioned problems.

The term “processor” refers to one or more hardware processing units, such as a central processing unit (CPU), graphics processing unit (GPU), dedicated accelerator, or a combination thereof, configured to execute instructions that implement the functions described in the claims.

The term “audio data” refers to digital data representing sound, including but not limited to voices of one or more speakers in an online meeting, conference, or other communication session, and optionally including background sounds associated with such sessions.

The term “character data” refers to textual data composed of characters, symbols, or code points in a predetermined character encoding, representing linguistic content derived from audio data or processed text.

The term “natural language processing technique” refers to a computational method or algorithm that processes and analyzes human language in text form, including but not limited to tokenization, part-of-speech tagging, parsing, language modeling, grammatical correction, and semantic analysis.

The term “grammatically and semantically” refers to aspects related to the grammatical correctness of sentences, such as syntax and morphology, and to the meaning and coherence of expressions, such as word choice, context consistency, and logical relationships between phrases or sentences.

The term “generative AI model” refers to a machine learning model, such as a transformer-based language model, that is trained to generate text or other content in response to input data, including prompts, and that can produce summaries or other natural language outputs.

The term “prompt” refers to an input text or structured instruction provided to a generative AI model, the content of which guides or constrains the behavior of the model in generating an output, such as a summary of corrected character data.

The term “summary” refers to a condensed representation of the content of the corrected character data, including at least a reduced-length text that captures principal topics, key points, decisions, or conclusions of the original content.

The term “acoustic characteristics” refers to measurable properties of audio data, including but not limited to pitch, intensity, energy, spectral features, prosody, speech rate, and temporal patterns, that can be analyzed to infer information such as emotion.

The term “linguistic content” refers to the textual or symbolic representation of spoken language obtained from audio data, including words, phrases, sentences, and their syntactic and semantic relationships.

The term “emotion” refers to an affective state associated with speakers and inferred from acoustic characteristics and linguistic content, such as, for example, neutrality, happiness, satisfaction, anger, frustration, or urgency.

The term “meeting” refers to a communication session in which two or more participants exchange spoken or audiovisual information, including but not limited to online conferences, teleconferences, webinars, and in-person meetings captured via recording devices.

The term “progress of a meeting” refers to a state or trend indicating how a meeting advances over time toward its objectives, including but not limited to aspects such as smoothness of discussion, presence of conflicts or tensions, degree of consensus, and overall engagement level, as evaluated based on recognized emotion.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

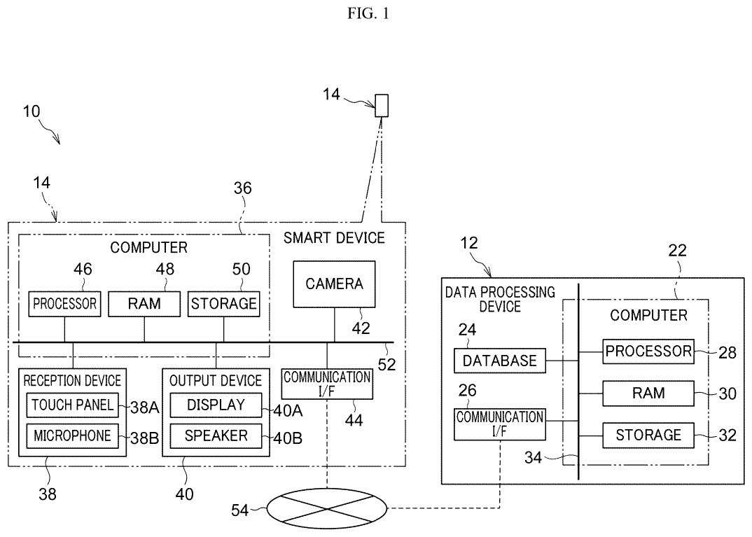

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

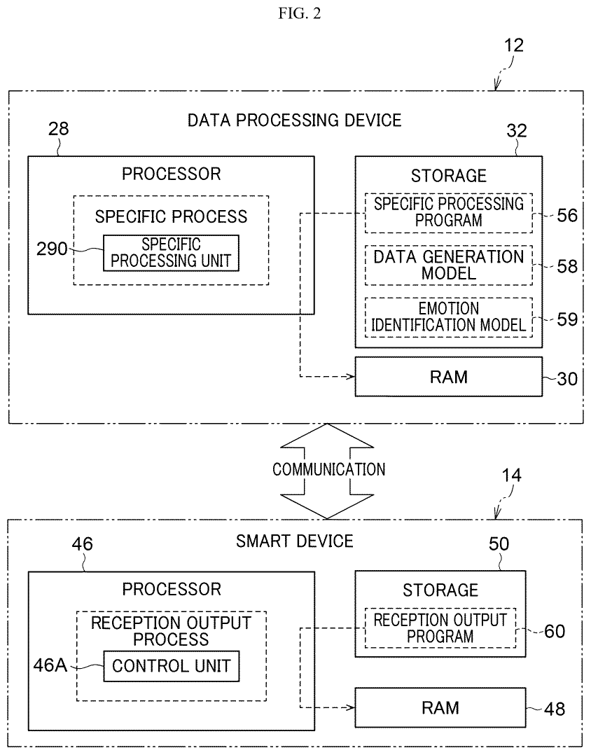

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional remote conferencing systems primarily focus on real-time communication and simple recording, and they typically provide raw audio recordings or basic transcripts without accurate structuring or intelligent post-processing. When audio data is converted into text, the conversion often suffers from recognition errors, lack of grammatical and semantic coherence, and absence of context-aware summarization. As a result, users must manually review long, unstructured transcripts or replay audio recordings, which is inefficient and error-prone.

In many existing solutions, the transcription component, the natural language processing component, and the summarization component are loosely coupled or entirely separate. Raw transcripts are not consistently corrected by advanced language models, and summary generation is not systematically tailored to the user's information needs. In particular, conventional systems do not generate prompt sentences in a structured, automated manner for controlling a generative AI model. Therefore, the generative model often receives ad-hoc or sub-optimal instructions, leading to summaries that are incomplete, inconsistent in format, or not aligned with the specific purpose of meeting analysis.

Furthermore, conventional conferencing analytics rarely integrate emotional analysis of participants' speech with textual summaries. Acoustic features and linguistic content are usually not jointly analyzed to recognize emotional states, and even when emotional states are detected, they are not used as explicit input conditions for generative models. Accordingly, the system cannot generate summaries or evaluations that reflect the dynamics of the discussion, such as tension, engagement, or consensus.

From a computer technology standpoint, there is a need for an improved system architecture and processing pipeline that (i) efficiently converts streaming conference audio into normalized digital signals, (ii) reliably obtains and stores character information, (iii) applies machine-learning-based natural language processing for grammatical and semantic correction, (iv) automatically constructs structured prompt sentences that specify summary content, output format, and extraction targets, and (v) uses these prompt sentences as control inputs to a generative AI model. There is also a need to computationally integrate recognized emotional states into the prompt sentences and into the evaluation logic so that the system can automatically assess meeting progress, discussion activity, and consensus formation. Such an integrated design can improve how computing resources handle, transform, and retrieve meeting information, thereby enhancing the technical performance and utility of conferencing information processing systems.

The specific processing by the specific processing unit 290 of the data processing device 12 in Example 1 is realized by the following means.

The present invention provides a server comprising a processor configured to receive conference audio information from a communication terminal and convert the conference audio information into digital signals of a predetermined format for speech recognition processing; to transmit the predetermined-format digital signals to an external information processing apparatus for speech recognition processing to obtain character information corresponding to the conference audio information and to store the obtained character information in an information storage apparatus; to apply natural language processing based on a machine learning model to the character information stored in the information storage apparatus so as to perform grammatical and semantic correction and to construct corrected character information as input information for summarization; to generate, on the basis of the input information for summarization, a prompt sentence that defines content of a summary, an output format, and target information for extraction, and to input the prompt sentence and the input information for summarization into a generative information processing model to cause the generative information processing model to generate summary information, and to store the generated summary information in association with the information storage apparatus; to analyze acoustic characteristics of the conference audio information and linguistic contents of the character information to recognize an emotional state and to include the recognized emotional state as additional information associated with the input information for summarization in the prompt sentence that is input to the generative information processing model; and to evaluate, on the basis of the emotional state and the summary information, at least one of a progress degree of a conference, an activity level of discussion, and a degree of consensus formation, to store an evaluation result as conference evaluation information in the information storage apparatus, and to output the conference evaluation information, together with search results based on user-specified search conditions, to a reception terminal. This enables the computing system to implement an integrated and technically improved processing pipeline in which streaming conference audio is normalized, transcribed, corrected, summarized, emotionally contextualized, and indexed in a coordinated manner, thereby enhancing the accuracy, relevance, and retrieval efficiency of meeting information while leveraging generative AI models through automatically constructed, task-specific prompt sentences.

The term “processor” refers to a hardware logic device or a combination of hardware logic devices, such as one or more central processing units, graphics processing units, or specialized processing circuits, configured to execute instructions and perform information processing operations.

The term “communication terminal” refers to an electronic apparatus, such as a client device including at least a microphone, a display, and a network interface, that transmits conference audio information and receives processing results via a communication network.

The term “conference audio information” refers to audio data representing speech or other sound generated during a conference conducted over a communication network, including signals captured from one or more participants by the communication terminal.

The term “digital signals of a predetermined format” refers to audio data that has been converted into a specified digital representation, including at least defined parameters such as sampling rate, bit depth, channel configuration, and encoding format, suitable for input to a speech recognition process.

The term “speech recognition processing” refers to a computational procedure that analyzes audio signals and outputs character information that represents a textual transcription of the spoken content contained in the audio signals.

The term “external information processing apparatus” refers to a remote or separate computing resource, such as a server or cloud-based system, that performs at least speech recognition processing in response to input digital signals received over a communication network.

The term “character information” refers to text data, including sequences of characters, symbols, and words, that are generated as a transcription result corresponding to conference audio information.

The term “information storage apparatus” refers to a storage subsystem, such as one or more memory devices or storage media including volatile memory, nonvolatile memory, or database systems, that stores character information, summary information, conference evaluation information, and associated metadata.

The term “machine learning model” refers to a parameterized computational model, trained using example data, that performs at least one of prediction, classification, or transformation of input information, including models implemented by statistical methods, neural networks, or other learning algorithms.

The term “natural language processing” refers to a set of computational techniques that analyze, interpret, transform, or generate human language text, including at least grammatical correction, semantic adjustment, entity detection, and text structuring.

The term “corrected character information” refers to character information that has been modified by natural language processing so that at least one of grammatical consistency, semantic coherence, or readability is improved relative to the original transcription.

The term “input information for summarization” refers to character information, including corrected character information and optionally metadata, that is prepared as input data used by a summarization process or a generative information processing model to generate summary information.

The term “prompt sentence” refers to a control input, comprising one or more sentences or text segments, that describes processing instructions, constraints, or desired output characteristics and that is provided to a generative information processing model together with input information for summarization.

The term “generative information processing model” refers to a machine learning model that generates new text or other information outputs in response to input information and a prompt sentence, including at least a generative artificial intelligence model configured to perform natural language generation.

The term “summary information” refers to text data that provides a condensed representation of content contained in character information, including at least extracted key points, decisions, tasks, or overviews of a conference.

The term “acoustic characteristics” refers to measurable properties of audio signals, including at least amplitude, pitch, energy, spectral distribution, and temporal variations, that can be used for analysis of speech or emotional state.

The term “linguistic contents” refers to the semantic and syntactic information represented by character information, including word choice, sentence structure, contextual relationships, and discourse features.

The term “emotional state” refers to an inferred affective condition associated with speech or text, such as levels of positivity, negativity, neutrality, stress, or engagement, estimated on the basis of acoustic characteristics and linguistic contents.

The term “conference evaluation information” refers to data representing one or more metrics related to the state or quality of a conference, including at least a progress degree, a discussion activity level, and a degree of consensus formation, which are computed on the basis of emotional state and summary information.

The term “reception terminal” refers to a client device, such as a user-operated terminal including a display and an input interface, that receives search results, summary information, and conference evaluation information from the server and allows a user to view and interact with such information.

The term “search conditions” refers to information specifying constraints or criteria for retrieving stored information, including at least keywords, identifiers, time ranges, participant attributes, or other parameters used to select character information, summary information, or conference evaluation information from the information storage apparatus.

In one embodiment, a server cooperates with one or more terminals and users to implement a conference information processing system that converts conference audio information into corrected character information, generates summary information using a generative AI model based on structured prompt sentences, and produces conference evaluation information including emotional state indicators.

A terminal includes at least a microphone, a display, a memory, and a network interface. The terminal executes conferencing software, such as a web-based communications client implemented with WebRTC, or native conferencing software comparable to common conferencing platforms. The terminal digitizes speech from one or more users using an audio codec (for example, linear PCM at 16 kHz, 16-bit, mono) and transmits conference audio information to the server via a communication network such as the Internet, using a transport protocol such as HTTPS or a persistent bidirectional protocol such as WebSocket.

A server includes at least one processor, a main memory, a non-volatile storage device such as a solid-state drive, and a network interface. The server executes server-side software implemented, for example, on an operating system such as a Unix-like operating system, using an application framework such as a Python-based framework or a JavaScript-based framework. The server further accesses an information storage apparatus, which may be implemented by a relational database management system such as a general-purpose database engine, or by a document-oriented database. The server also accesses an external information processing apparatus for speech recognition, such as a cloud-based speech recognition service that provides an API for uploading audio and receiving text transcriptions. Furthermore, the server communicates with a generative AI model, which may be provided as a cloud-based generative text model accessible via an HTTP API, or as an on-premises transformer-based neural network executed on a graphics processing unit.

The server converts incoming conference audio information into digital signals of a predetermined format. The server uses an audio processing library, such as a multimedia processing library, to perform operations including resampling (for example, to 16 kHz), channel mixing (for example, to mono), and encoding (for example, to WAV or FLAC). The server stores the transformed digital signals in a buffer in main memory and, optionally, in temporary storage in the file system, together with identifiers such as a meeting identifier, a participant identifier, and segment timestamps. By enforcing a normalized audio format at the server side, the system reduces errors and processing overhead in downstream speech recognition, improving computation efficiency and recognition accuracy.

The server transmits the normalized digital signals to the external information processing apparatus for speech recognition. The server segments the audio into units of predefined duration, such as 5 -15 seconds, and encapsulates each segment in a request message containing the meeting identifier, segment index, language information, and recognition configuration parameters. The external apparatus applies a speech recognition model, such as an acoustic model combined with a language model, and returns character information in a structured format, including recognized text, time alignment information, and confidence scores for each segment.

The server receives the character information and stores it in the information storage apparatus. The server constructs a data structure for each segment, including at least a primary key, meeting identifier, speaker identifier (if determined), start and end timestamps, recognized text, recognition confidence, and a processing status flag. The server inserts or updates rows in tables such as a transcript table and an auxiliary index table. In one variation, the server also constructs inverted indexes or n-gram indexes to support efficient full-text search. Because the character information is stored with fine-grained timestamps and structured metadata, the system enables precise retrieval of specific parts of a conference.

The server applies natural language processing based on a machine learning model to the stored character information. In one embodiment, the server loads a transformer-based model, such as an encoder-decoder neural network or an encoder-only neural network, using a machine learning framework such as a general-purpose deep learning library. The server may use a model architecture including multiple layers of self-attention and feed-forward sublayers, with learned parameters stored as floating-point weight matrices. The server uses a tokenizer to map character sequences into token identifiers, applies attention mask construction, and feeds token sequences into the model. The server performs tasks including:
grammatical and syntactic correction by predicting replacement tokens or token sequences with higher model probability under the language model;
semantic normalization by removing repeated segments, resolving truncated sentences, and unifying terminology;
segmentation of the transcript into sentences and sections based on predicted sentence boundary tokens and discourse markers.

The server aggregates model outputs into corrected character information. The server may compute a confidence measure for each corrected segment by combining the original speech recognition confidence with the model's token-level probabilities, and stores this measure in the database. By using an attention-based model specifically trained or fine-tuned for noisy transcripts, the server can improve the overall quality of the text beyond simple rule-based correction, reducing error propagation into subsequent summarization steps.

The server constructs input information for summarization by concatenating corrected character information segments in chronological order, optionally inserting markers that encode speaker changes, timestamps, and recognized emotional states. The server may also define a structured data representation, such as a document object containing fields for raw text, corrected text, speaker labels, and derived features like section headings or key phrases. This structured representation ensures that summarization is applied to contextually coherent content units, which improves the technical performance of the generative model in terms of content coverage and consistency.

The server recognizes an emotional state associated with the conference audio information and the character information. In one embodiment, the server computes acoustic features from the digital signals, including short-time energy, fundamental frequency (pitch), spectral centroid, spectral flux, Mel-frequency cepstral coefficients, and other prosodic features, using a digital signal processing library. The server also computes linguistic features from the character information, including sentiment polarity scores, presence of intensifiers, hedging expressions, and certain domain-specific keywords. The server feeds a feature vector combining acoustic and linguistic features into a classification model, which may be a feed-forward neural network or a recurrent neural network trained to output emotional state categories such as positive, neutral, negative, and high-stress.

The server associates the recognized emotional state with time ranges and segments of the transcript. The server stores emotional labels and corresponding scores in the information storage apparatus as additional attributes of the transcript segments or as entries in a separate emotion table. This design enables the server to treat emotional state as a machine-readable feature that can be used both for conference evaluation and for conditioning the generative AI model's behavior.

The server generates a prompt sentence for the generative AI model. The server constructs a textual control input that describes at least (i) the desired type of output (for example, bullet-point summary, list of action items, high-level overview), (ii) an output format (for example, plain text list, paragraph format, or structured textual format), (iii) target information for extraction (for example, decisions, next steps, assignments), and (iv) optional constraints based on recognized emotional states or meeting context (for example, focusing on segments with high engagement). The server may use a template-based rule system to assemble the prompt, where specific clauses are added or removed based on metadata, or may train a separate model to optimize prompt generation. Examples of prompt sentences include:

“The following text is an automatically transcribed meeting. Clean up recognition errors, fix grammar, and keep the original meaning. Output only the corrected transcript:

[meeting transcript text here].”

“Summarize the following remote meeting. Focus on decisions, next steps, and responsible persons. Return the result as bullet points:

[meeting transcript text here].”

“From the following meeting transcript, extract all action items with assignees and deadlines. Return the result as a plain text list of tasks:

[meeting transcript text here].”

“Create a short digest of the following meeting that emphasizes topics related to project schedule and budget. Limit the digest to about 150 words:

[meeting transcript text here].”

In another example, the server embeds emotional state information in the prompt sentence, such as:

“The following transcript includes emotional markers indicating high tension or high engagement. When you summarize the meeting, highlight the segments with high engagement and indicate where tension was high:

[meeting transcript text with markers here].”

By programmatically constructing such prompt sentences from structured metadata and recognized features, the server controls the generative AI model in a non-conventional way. Rather than simply relaying raw text, the server reformulates the task in a precise way that uses internal data structures, emotional annotations, and summary objectives, resulting in improved reliability and consistency of the generated summaries. This is a technical improvement in the way the computing system uses generative models, leading to more predictable and resource-efficient processing.

The server sends the prompt sentence and the input information for summarization to the generative AI model. When using a cloud-based generative model, the server constructs an HTTP request with parameters specifying, for example, a model identifier, maximum output tokens, and sampling temperature. The server embeds the prompt sentence and, where required, the transcript text in the request body. The generative AI model may be a transformer-based neural network comprising multiple decoder layers, each layer including multi-head self-attention, cross-attention, and feed-forward components, trained using an auto-regressive language modeling objective with a loss function such as cross-entropy. During inference, the generative model computes token logits at each step, applies softmax to obtain probability distributions, and selects output tokens by greedy decoding or beam search.

The server receives the generated output tokens from the generative AI model, decodes them to text via the tokenizer, and stores the resulting summary information in the information storage apparatus. The server associates each summary with the corresponding meeting identifier, a summary type (for example, full summary, action-item summary, sentiment-aware summary), and generation parameters (for example, model version, prompt template identifier). The server may also compute quality metrics for summary information, such as length, coverage ratio, and overlap with key phrases identified by the machine learning model, and store these metrics as metadata to support later evaluation or re-generation. By storing the summary information and its generation context in structured form, the system makes summary retrieval and version management efficient and technically robust.

The server evaluates at least one of a progress degree of a conference, a discussion activity level, and a degree of consensus formation using the emotional state and the summary information. For example, the server may compute a progress degree by comparing the number and coverage of agenda items referenced in the summary against a predefined agenda stored as structured data. The server may quantify discussion activity level by aggregating acoustic features indicating speech energy and variance, combined with the variety of topics detected in the transcript and summary. The server may estimate degree of consensus formation by detecting phrases such as “we agree,” “decided that,” or “final decision,” using both rule-based phrase matching and model-based detection. The server stores conference evaluation information, comprising these computed metrics and indicators, in the information storage apparatus and links them to the meeting record.

A user accesses the system through a terminal. The user inputs search conditions specifying at least keywords, time periods, or participant identifiers, via a graphical user interface implemented as a web application. The terminal transmits the search conditions to the server over the network. The server retrieves character information, summary information, and conference evaluation information that match the search conditions using full-text search mechanisms, index-based retrieval, or a combination thereof. The server packages the results and sends them to the terminal. The terminal renders the transcripts with highlighted keywords, displays summary information and emotional state indicators, and may provide visualizations of conference evaluation metrics, such as timelines of engagement levels or consensus formation.

From a computer technology perspective, this architecture improves the functioning of the computer system itself. The server enforces a normalized audio format and segment-based processing to reduce computational overhead and network bandwidth consumption. The server integrates multiple machine learning components—speech recognition, linguistic correction, emotional classification, and generative summarization—through standardized data structures and explicit prompt sentences, thereby reducing redundant processing and improving throughput. Technical effects include:
improved transcription accuracy due to joint use of speech recognition confidence and language-model-based correction;
improved summarization quality and consistency resulting from structured prompt generation that exploits metadata and emotional state;
reduced storage and retrieval cost because summary information and conference evaluation information provide compact, indexable representations of large audio datasets;
improved computational efficiency through segment-based parallelization, allowing the server to process multiple segments and multiple meetings concurrently using multi-core processors and GPUs.

The server uses learning algorithms with explicit training methods. For example, the emotional state classifier may be trained with a supervised learning procedure using labeled audio-text pairs. The server applies a loss function such as categorical cross-entropy to measure prediction error and updates network weights using an optimization algorithm such as stochastic gradient descent with momentum or an adaptive optimizer. Data augmentation methods, such as time-stretching of audio or synonym replacement in text, may be used to improve model robustness. The language correction model and summarization model may similarly be fine-tuned on domain-specific data, such as past meeting transcripts and human-edited summaries. Because the server applies these trained models in a coordinated data flow and uses their outputs to construct machine-readable control inputs (prompt sentences) for the generative AI model, the system operates according to machine-oriented rules and algorithms that are distinct from human ad-hoc editing or summarization.

In alternative embodiments, the server may integrate the speech recognition process locally instead of using an external information processing apparatus. In such cases, the server loads an acoustic model and a language model into local memory and performs decoding directly on the normalized digital signals, using algorithms such as beam search and connectionist temporal classification. In another variation, the generative AI model may be deployed on-premises on a dedicated inference server equipped with multiple GPUs. In yet another variation, the emotional state recognition may be extended to multi-dimensional outputs, such as separate scores for arousal and valence, or may be combined with speaker diarization information to provide per-speaker emotional profiles.

In all these embodiments, the server, the terminal, and the user cooperate in a way that leverages concrete hardware resources, specific software components, and specialized data structures and algorithms to transform raw conference audio into structured, searchable, and emotionally contextualized information. The described configurations are not limited to business meetings and may be applied to technical design reviews, educational sessions, or remote hearings, as long as conference audio information is acquired and processed according to the mechanisms described herein.

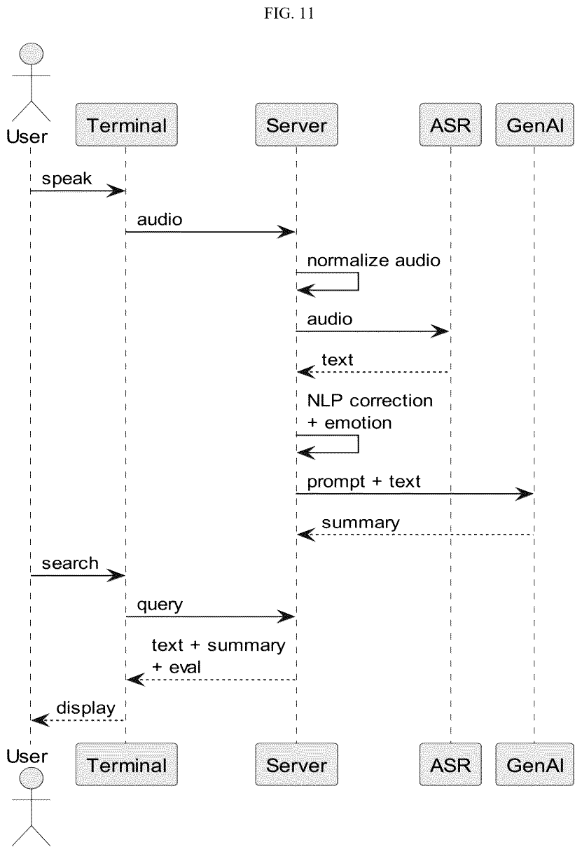

The following describes the processing flow using FIG. 11.
Step 1:

The terminal acquires conference audio information from a user and prepares it for transmission.

The terminal uses its microphone to capture the user's speech and converts the analog audio signal into a digital audio stream (for example, 16 kHz, 16-bit, mono PCM). The input to this step is an analog sound wave produced by one or more users. The terminal performs analog-to-digital conversion and encodes the samples into audio frames, adds meeting identifiers and timestamps as headers, and stores the frames in a send buffer in memory. The output of this step is a sequence of timestamped digital audio packets ready to be sent to the server via a network interface.
Step 2:

The terminal transmits the digital audio packets to the server over a communication network.

The input to this step is the sequence of buffered audio packets generated in Step 1. The terminal segments the stream into packets of a fixed duration (for example, 5 seconds per packet), encapsulates each packet in a network message (for example, an HTTPS POST or WebSocket frame), and attaches metadata including meeting ID, participant ID, and packet index. The terminal uses a network protocol stack to send these messages to a predetermined server endpoint. The output of this step is a set of network messages containing audio packets that arrive at the server.
Step 3:

The server receives the digital audio packets and normalizes the audio format.

The input to this step is a stream of incoming audio packets carrying compressed or uncompressed digital audio data and associated metadata. The server stores each incoming packet in a memory buffer and reconstructs the original time order by sorting or indexing packets based on meeting ID and packet index. The server applies an audio processing library to resample the audio to a predetermined sampling rate (for example, 16 kHz), convert bit depth (for example, to 16-bit), and mix channels to mono if necessary. The server also converts the audio into a required container format (for example, WAV). The output of this step is a normalized digital audio segment file or buffer for each time interval of the conference, tagged with identifiers and timestamps.
Step 4:

The server sends normalized audio segments to an external information processing apparatus for speech recognition and receives character information.

The input to this step is the set of normalized digital audio segments generated in Step 3. The server constructs an API request for each segment, embedding the audio data and recognition parameters (language code, recognition mode, model type) into a request body. The server transmits the request to the external apparatus and waits for the response. The external apparatus executes speech recognition and returns a response containing recognized text, per-word timestamps, and confidence scores. The server parses the response, extracts the recognized text and metadata, and associates them with the original meeting and segment identifiers. The output of this step is a collection of character information records corresponding to each audio segment.
Step 5:

The server stores the character information and metadata in an information storage apparatus.

The input to this step is the character information records from Step 4, including recognized text, timestamps, speaker identifiers (if known), and confidence values. The server constructs database records, assigning a primary key, meeting ID, segment index, start time, end time, recognized text, and recognition confidence. The server executes insert or update operations via a database driver or ORM to write these records into tables such as a transcript table and an index table. The server may also update full-text search indexes based on the recognized text. The output of this step is a persistent, searchable set of transcript entries stored in the information storage apparatus.
Step 6:

The server retrieves stored character information for a conference and performs natural language processing to generate corrected character information.

The input to this step is a set of transcript entries selected from the information storage apparatus based on a meeting ID. The server issues a database query to retrieve all segments in chronological order, then concatenates their recognized text into longer text blocks, adding markers for segment boundaries and speakers. The server then applies a machine learning model for natural language processing, such as a transformer-based neural network, using a tokenizer to convert the text into token IDs. The server feeds the token sequences to the model, which performs operations such as grammatical correction, sentence boundary detection, and removal of repeated fragments. The model outputs corrected token sequences that the server decodes back into text. The output of this step is corrected character information, stored as text segments or documents with updated processing status flags and optional correction confidence scores.
Step 7:

The Server Analyzes Acoustic Characteristics And Linguistic Contents To Recognize Emotional states.

The input to this step is (i) the normalized digital audio segments from Step 3 and (ii) the character information or corrected character information from Step 6. The server computes acoustic features (for example, energy, pitch, spectral centroid, and Mel-frequency cepstral coefficients) over fixed-length frames of the audio segments and aggregates them into feature vectors. The server also computes linguistic features from the transcripts, such as sentiment scores, frequency of emphasis words, and presence of specific cues (for example, “concerned,” “urgent,” “agree”). The server concatenates acoustic and linguistic feature vectors and feeds them into an emotional state classifier, such as a feed-forward neural network trained to output categorical or continuous emotional labels. The classifier performs matrix multiplications and non-linear activations to generate predicted emotional states with associated probabilities. The output of this step is emotional state information for each time interval or transcript segment, which the server stores in the information storage apparatus linked to segment identifiers.
Step 8:

The server constructs input information for summarization and generates a prompt sentence for a generative AI model.

The input to this step is corrected character information from Step 6 and emotional state information from Step 7. The server groups text into sections based on time, speaker changes, or topic shifts, and annotates sections with emotional markers or metadata. The server then constructs input information for summarization by combining the corrected text and selected metadata into a structured internal representation, such as a document object containing fields for main text, speaker labels, and emotional flags. Using predefined templates and rules, the server assembles a prompt sentence that specifies the summarization task, desired output format, and extraction targets. The server may include examples such as:

“Summarize the following remote meeting. Focus on decisions, next steps, and responsible persons. Return the result as bullet points:”

and then append the relevant transcript text.

The output of this step is a pair consisting of (i) a prompt sentence and (ii) the associated input information for summarization prepared for submission to a generative AI model.
Step 9:

The server transmits the prompt sentence and input information for summarization to a generative AI model and obtains summary information.

The input to this step is the prompt sentence and the associated summarization input prepared in Step 8. The server constructs a request message that includes the prompt sentence and, if required by the API, the transcript text as part of the input. The server sends the request to an external generative AI model endpoint, specifying parameters such as maximum output length and decoding strategy. The generative AI model internally applies a decoder architecture to sequentially compute probability distributions over possible next tokens based on the prompt and prior tokens. The server receives the response, which contains a generated summary as a sequence of tokens, decodes the tokens to text, and separates the summary into elements such as bullet points or paragraphs according to delimiters. The output of this step is summary information text that describes key points, decisions, and other extracted content of the conference.
Step 10:

The server stores the summary information and associated conference evaluation information in the information storage apparatus.

The input to this step is the summary information from Step 9 and the emotional state and transcript metadata from previous steps. The server creates a summary record containing a meeting ID, summary type, generation timestamp, prompt template identifier, and the summary text. The server inserts this record into a summary table in the database. Using the emotional state information and the content of the summary, the server computes conference evaluation metrics, such as progress degree, discussion activity level, and degree of consensus formation, using predefined algorithms (for example, counting the number of resolved agenda items, measuring variability of emotional state over time, detecting decision phrases). The server stores these metrics as conference evaluation records linked to the meeting ID. The output of this step is a set of stored summary records and evaluation records that are available for later retrieval.
Step 11:

The user issues search conditions from a terminal to retrieve transcripts, summaries, and conference evaluation information.

The input to this step is a user's query, entered via a search interface on the terminal, which may include keywords, date ranges, participant names, or meeting identifiers. The terminal packages the search conditions into a request message and sends it to the server over the network. The server receives the search request, parses the conditions, and converts them into database queries or search engine queries, possibly including full-text search and filtering by metadata. The server executes these queries to retrieve matching transcript entries, summary records, and conference evaluation records. The output of this step is a collection of search results that the server formats into a response containing the relevant text segments, summaries, and evaluation metrics.
Step 12:

The terminal displays the retrieved transcripts, summaries, and conference evaluation information to the user.

The input to this step is the response sent by the server in Step 11, which contains structured data for matching transcripts, associated summary information, and conference evaluation metrics. The terminal parses the response and renders the results on a display using a graphical user interface. The terminal may highlight matched keywords in the transcripts, present summaries as bullet lists or paragraphs, and show evaluation metrics as numeric indicators or charts. The terminal enables the user to scroll, filter, or select specific segments for detailed viewing. The output of this step is a visual and interactive presentation of the processed conference information that the user can understand and utilize for review, decision making, or further analysis.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In network-based remote conferencing environments, conventional systems that record meeting audio and generate transcripts suffer from several technical limitations that reduce the usefulness and efficiency of the underlying computer technology. First, known systems typically perform one-way conversion from audio signals to text using speech recognition engines and then simply store or display the raw transcript. Such systems do not adequately correct recognition errors, restore punctuation, or normalize language, which results in low-quality text data that is difficult for downstream modules to process. As a consequence, servers and client devices must repeatedly render and search through large, noisy text streams, increasing processing load, memory usage, and network traffic.

Second, conventional systems generally do not leverage generative models in a structured and controllable manner. In particular, they do not use explicitly constructed prompt sentences that encode constraints such as summary length, format, and target information type. As a result, when general-purpose generative models are applied directly to meeting transcripts, the output is often inconsistent in length and structure, and sometimes omits important information. This lack of control over model behavior leads to unpredictable processing results and requires additional manual or ad hoc filtering, which wastes computational resources and degrades overall system reliability.

Third, many existing solutions do not perform hierarchical or multi-stage summarization that is aligned with temporal structures of meetings, such as time intervals or agenda units. They either attempt to summarize an entire meeting transcript in a single pass or generate fragmented summaries without explicit association to time information. This makes it difficult for a server to index and retrieve summary information efficiently, and forces user terminals to handle large, unstructured data sets. As a consequence, navigation between summarized content and underlying audio or text requires heavy computations on the client side, and real-time or near real-time summarization is technically challenging.

Fourth, traditional meeting support systems typically do not integrate summary information into the core control logic of the conferencing platform. They do not evaluate meeting progress based on machine-generated summaries, and they do not provide machine-interpretable signals that can drive adaptive user interfaces, resource allocation, or automated notifications. As a result, servers cannot automatically detect stagnation, missing agenda items, or incomplete decision-making, and cannot optimize scheduling or guidance for participants based on an objective, machine-generated representation of meeting content. Accordingly, there is a need for an improved computer-implemented system in which a processor cooperatively performs (i) acquisition and transmission of audio information, (ii) speech recognition to obtain character information, (iii) grammatical and semantic correction using a machine learning-based natural language processing technique, (iv) controlled summary generation using prompt sentences input to a generative language model, and (v) hierarchical aggregation and storage of summary information associated with time information. Such a system should reduce processing complexity on terminals, improve the quality and structure of machine-generated summaries, and enhance the ability of the server to evaluate and manage meeting progress, thereby improving the overall performance and functionality of the underlying computer technology.

The specific processing by the specific processing unit 290 of the data processing device 12 in Application Example 1 is realized by the following means.

The present invention provides a server comprising a processor configured to acquire audio information associated with a remote conference from a terminal device via a communication path, convert the acquired audio information into character information by executing speech recognition processing, correct the character information grammatically and semantically by executing a natural language processing technique implemented with a machine learning model, generate a prompt sentence including conditions for summary generation on the basis of the corrected character information, input the prompt sentence together with the corrected character information into a generative language model to cause the generative language model to generate summary information, aggregate the generated summary information on at least one of a meeting unit basis and a time-interval unit basis and input the aggregated summary information into the generative language model to cause the generative language model to generate overall summary information, store the summary information and the overall summary information in association with time information of at least one of the audio information and the character information in a storage medium, and distribute at least one of the summary information and the overall summary information to the terminal device via the communication path for display at the terminal device. This enables the server to perform controlled and hierarchical summarization of conference content using prompt-driven generative processing, to maintain structured associations between summary data and temporal metadata, and to deliver compact, machine-processed representations of meetings that reduce client-side computation, improve retrieval and navigation efficiency, and enhance the overall performance and technical capabilities of network-based conferencing systems.

The term “audio information” refers to data representing sound signals, including speech uttered by one or more participants in a meeting, that has been captured by an input device and digitized for processing by a computing device.

The term “communication path” refers to a logical or physical connection, including wired and wireless networks, over which data is transmitted between a server and a terminal device.

The term “terminal device” refers to an information processing apparatus operated by a user, including but not limited to a mobile device, a personal computer, or a tablet device, that is configured to send audio information to a server and display information received from the server.

The term “speech recognition processing” refers to computerized processing that analyzes audio information and converts the audio information into character information representing textual content of the speech.

The term “character information” refers to data representing text obtained by converting audio information into a sequence of symbols, such as letters, characters, or words, suitable for natural language processing.

The term “natural language processing technique” refers to a computational method for analyzing and transforming character information, including tasks such as grammatical correction, semantic correction, punctuation restoration, and normalization.

The term “machine learning model” refers to a trained computational model, including but not limited to a neural network, that processes input data and generates output data based on parameters obtained through a learning process using training data.

The term “generative language model” refers to a type of machine learning model configured to generate character information, including summaries or reformulations of input text, in response to input data and conditions.

The term “prompt sentence” refers to character information that includes instructions, conditions, or constraints, supplied to a generative language model together with other input data, to control content, format, or length of generated output.

The term “summary information” refers to character information that concisely represents important portions of original character information derived from audio information, and that is generated by the generative language model based on the prompt sentence.

The term “overall summary information” refers to summary information generated by the generative language model on the basis of aggregated summary information corresponding to multiple segments of a meeting or multiple time intervals.

The term “meeting unit basis” refers to a unit of processing or aggregation corresponding to an entire meeting session identified by a meeting identifier or similar control information.

The term “time-interval unit basis” refers to a unit of processing or aggregation corresponding to a discrete temporal segment of a meeting, defined by start time and end time or by periodic time intervals.

The term “storage medium” refers to any non-transitory computer-readable medium, including semiconductor memory, magnetic storage, and optical storage, that is configured to store program code and data such as audio information, character information, and summary information.

The term “time information” refers to data indicating temporal attributes of audio information or character information, including recording time, start time, end time, or timestamps associated with segments of a meeting.

The term “processor” refers to one or more hardware processing units, such as a central processing unit, a graphics processing unit, or a dedicated accelerator, configured to execute program instructions and perform the functions described in the claims.

In the following embodiments, a server, a terminal, and a user cooperate to implement the claimed invention. The same reference configuration can be realized with various hardware and software platforms as described below, and any suitable modifications apparent to one skilled in the art are intended to be encompassed.

### A. Overall System Configuration

The server includes at least one processor, a main memory, a non-volatile storage device, a network interface, and optionally a dedicated accelerator. The processor is, for example, a multi-core central processing unit, and the accelerator is, for example, a graphics processing unit configured for parallel numerical computation. The non-volatile storage device is, for example, a solid-state drive managed by an operating system such as a UNIX-like operating system. The network interface is connected to an external packet-switched network such as an internet protocol network.

The terminal includes at least one processor, a memory, a network interface, a display, an audio input device, and optionally an audio output device. The audio input device is, for example, a microphone integrated into a mobile computing device or a headset connected to a personal computer. The terminal executes an application, such as a native mobile application or a web application running in a browser, configured to capture audio information and to display summary information distributed from the server.

The user operates the terminal in order to participate in a remote conference, to allow the terminal to acquire audio information, and to view and navigate summary information and detailed transcript information generated by the server.

### B. Functional Modules of the Server

The server implements a plurality of functional modules as software components executed by the processor. In one embodiment, the server executes an application framework such as a web server process and an application logic process. The following modules are realized either as separate processes or as logically separated components:
(1) An audio reception module;
(2) A speech recognition interface module;
(3) A transcript correction module;
(4) A summary generation module including a generative AI model interface;
(5) An aggregation and storage module; and
(6) A meeting progress evaluation module.

The audio reception module manages network sockets provided by the operating system, receives audio information encapsulated in transport-layer packets, reconstructs audio streams, and stores the reconstructed audio information in the storage device. The audio reception module associates each incoming audio segment with metadata including a meeting identifier, a participant identifier, and start and end timestamps.

The speech recognition interface module communicates with a speech recognition engine. In one embodiment, the speech recognition engine is provided by an external service accessed via an application programming interface. The speech recognition interface module encodes the audio information into a format required by the engine, such as linear pulse-code modulation or a compressed waveform container, and transmits the encoded data to the engine. The speech recognition interface module receives a response comprising recognized character information and confidence scores, and converts the response into internal data records.

The transcript correction module performs natural language processing on the character information. In one embodiment, the transcript correction module is implemented using a machine learning model of a neural network architecture, such as an encoder-decoder model based on self-attention layers. The transcript correction module accesses a trained parameter set stored in the storage device and loads it into the main memory for execution.

The summary generation module constructs a prompt sentence, combines the prompt sentence with corrected character information, and supplies both to a generative AI model. In one embodiment, the generative AI model is a large-scale language model realized as a multi-layer transformer network. The summary generation module receives generated summary information as output from the generative AI model and performs post-processing such as removal of redundant expressions and normalization of terminology.

The aggregation and storage module aggregates summary information for segments of a meeting to generate data structures representing a meeting-level overview. The aggregation and storage module stores summary information and overall summary information, together with associated time information and identifiers, in a non-volatile database. The aggregation and storage module also prepares data sets for later retrieval and distribution to terminals.

The meeting progress evaluation module analyzes summary information and overall summary information to infer an objective state of a meeting. For example, the meeting progress evaluation module detects whether specified topics have been covered, whether decisions have been recorded, and whether a meeting is converging or diverging. The meeting progress evaluation module generates evaluation indicators and stores them with time information.

### C. Functional Modules of the Terminal

The terminal implements a capture and transmission module, a display and interaction module, and optionally a local caching module.

The terminal uses the capture and transmission module to sample analog signals from the microphone at a predetermined sampling frequency and bit depth, to buffer the audio information in memory, and to transmit the buffered audio information to the server via a network protocol stack. The terminal may compress the audio information using an audio codec to reduce communication load before transmission.

The terminal uses the display and interaction module to present user interface components on the display unit. The display and interaction module renders textual elements representing summary information, overall summary information, and detailed transcript segments. The display and interaction module accepts user input via touch, keyboard, or pointing devices and translates user input into control signals directed to the server, such as requests for additional detail or navigation to specific time intervals.

The terminal uses the local caching module to store recently received summary information and transcript extracts in its memory. This caching reduces repeated network requests and improves response time when the user scrolls through summary information.

### D. Data Structures

The server uses specific data structures in order to manage and process information efficiently. The server represents audio information as a sequence of audio segments. Each audio segment is stored with metadata, including segment identifier, meeting identifier, participant identifier, start time, end time, and a pointer to the corresponding audio file stored in the storage device.

The server represents character information as transcript entries. Each transcript entry includes a transcript identifier, a sequence of tokens, a language code, an associated audio segment identifier, and confidence scores for recognition. The transcript correction module writes corrected transcript entries that reference original transcript entries. Corrected transcript entries include normalized text and additional tags representing sentence boundaries and parts of speech.

The server represents summary information as summary records. Each summary record includes a summary identifier, a text field containing the summary information generated by the generative AI model, a list of references to underlying corrected transcript entries, and a time interval spanning the summarized content. The server represents overall summary information as higher-level summary records that reference a set of summary records and represent an entire meeting or a large portion thereof.

These data structures permit the server to perform indexed retrieval by meeting identifier and time range, thereby reducing the need for full-text scanning and improving computational efficiency.

### E. Generative AI Model and Prompt Sentence Construction

The server uses the summary generation module to formulate a prompt sentence and to control the behavior of the generative AI model. The server constructs the prompt sentence by inserting specific summary generation conditions into a fixed template. For example, the server generates a prompt sentence such as: “Please summarize the following remote meeting content in English. Focus on key decisions, action items, and dates. Output 3-5 concise bullet points.”

The server appends corrected transcript text after this prompt sentence, separated by a delimiter. In another example, the server generates a prompt sentence such as:

“You are an assistant that summarizes remote conference transcripts.

Input: A list of bullet points transcribed and corrected from a meeting.

Task: Generate a short summary (3-5 sentences) that captures the main topics and decisions.

Meeting content:
1. Discuss the release date of the new product.
2. Review the marketing strategy.
3. Adjust the schedule for the next meeting.”

The server includes parameters in the prompt sentence that specify maximum number of tokens, desired style (e.g., bullet list vs. paragraph), and degree of compression. By consistently encoding such conditions into the prompt sentence, the server causes the generative AI model to produce outputs that are uniform in length and structure, which reduces post-processing complexity and memory usage.

In one embodiment, the generative AI model is implemented as a transformer-based neural network having multiple encoder and decoder layers, multi-head self-attention, and feed-forward sub-layers. The model parameters are learned by minimizing a loss function, such as a cross-entropy loss, over training pairs comprising input text and target summary text. The server or an associated training system performs weight updates using gradient-based optimization, such as stochastic gradient descent with adaptive moment estimation. During inference, the server executes the decoder with beam search or nucleus sampling to generate summary information within a specified maximum token length.

The server distinguishes the present system from simple automation of human summarization by imposing machine-interpretable constraints through the prompt sentence and by ordering model inference according to the time-structured data structures described above. The server thereby transforms raw meeting audio into a multi-layer representation that is optimized for computer retrieval and temporal navigation, rather than simply replicating human reading behavior.

### F. Transcript Correction Model

The server uses the transcript correction module to improve the quality of character information and to reduce error propagation into the summary generation stage. In one embodiment, the server implements a sequence-to-sequence neural network with attention. The input to this model is a tokenized representation of the raw transcript. The model includes an encoder that transforms the input token sequence into a sequence of hidden vectors, and a decoder that generates corrected tokens one by one.

The server trains the transcript correction model using pairs of noisy transcripts and manually corrected texts. The server uses features such as token identity, token position, part-of-speech tags, and punctuation markers. The loss function measures the difference between the generated corrected sequence and a reference corrected sequence. The server updates the model weights to reduce the loss function using gradient descent. The server may apply data augmentation methods, such as noise injection into training text, to make the model robust to various recognition errors.

During operation, the server uses the processor and, when available, a graphics processing unit, to execute the forward pass of the transcript correction model. The server converts raw character information into token identifiers, performs embedding lookup, and propagates the activations through multiple network layers. This processing structurally alters the input data into a corrected form that aligns better with language norms. The reduction of grammatical inconsistencies and missing punctuation reduces the search space for the generative AI model, leading to faster convergence during decoding and improving generation quality.

### G. Meeting Progress Evaluation

The server uses the meeting progress evaluation module to analyze the content of summary information and overall summary information. The server parses the summary information to detect occurrences of predefined keywords or semantic patterns representing agenda items, decisions, and unresolved issues. The server maintains counters and state variables representing coverage of agenda topics and progress status.

The server applies rule-based logic or a learned classifier to the state variables and summary content. For example, the server determines that a meeting has progressed to a “decision reached” state when the summary information contains phrases indicating finalization of a proposal. The server computes an evaluation score for the meeting, such as a completion percentage, and associates that score with a time interval. The server transmits the evaluation result to the terminal, which displays progress indicators to the user.

By mapping summary information to progress metrics inside the server, the system provides feedback that cannot be obtained simply by reading or listening. The server reduces the need for the user to manually scan long transcripts to determine the meeting state, thereby improving the effectiveness of the conferencing infrastructure.

### H. Technical Effects and Improvement of Computer Technology

The server improves computer technology in several respects. First, the combination of transcript correction and controlled summarization based on prompt sentences reduces the size and complexity of textual data that must be transmitted to and processed by the terminal. Because the server executes correction and summarization before distribution, the terminal receives compact summary information instead of entire transcripts. This reduces communication load and processing requirements on the terminal and improves battery life and responsiveness.

Second, the server uses the hierarchical data structures and time-aligned summary records to support efficient indexing and retrieval. The server can directly access summary information for specific intervals without scanning full transcripts. This reduces input/output operations on the storage device and decreases latency when the user requests to view specific sections of the meeting. The technical benefit arises from the alignment of summary information with time information and meeting identifiers, not merely from an abstract data manipulation.

Third, the server controls the generative AI model with explicit prompt sentences that encode strict summary generation conditions. This control reduces variance in output length and format, which in turn simplifies memory allocation and rendering on the terminal. The server can pre-allocate buffers and layout templates based on known output constraints. This is distinct from merely applying a generic language model; the server uses prompt engineering as a technical mechanism to stabilize system behavior and to improve resource management.

Fourth, the server's transcript correction and summarization pipeline reduces cumulative error and improves precision of downstream indexing and evaluation. By suppressing recognition artifacts using a trained correction model, the server avoids spurious tokens that would otherwise degrade the performance of the generative AI model and the meeting progress evaluation module. As a result, the server achieves better accuracy in detecting agenda completion and in aligning summary segments with time intervals.

Fifth, the use of neural network architectures with specific learning procedures, loss functions, and data augmentation methods is tailored to the domain of remote conferencing. The server does not merely emulate human correction and summarization; it applies non-intuitive, high-dimensional optimization processes that cannot practically be performed by human operators. The server thereby transforms the structure and distribution of data in internal feature spaces, enabling faster and more accurate inference when processing future meeting data.

### I. Variations and Alternative Embodiments

The server may replace the external speech recognition engine with a locally hosted acoustic and language model executed on its own processor or graphics processing unit. In such an embodiment, the server directly performs feature extraction on audio information, such as computation of mel-frequency cepstral coefficients, and applies a deep neural network acoustic model followed by a language model to decode character information.

The server may modify the generative AI model architecture. For example, the server may use a recurrent neural network with attention instead of a transformer, or may apply a hybrid model that combines extractive and abstractive summarization. The server may adjust hyperparameters such as number of layers, hidden unit size, and attention head count to meet computational constraints.

The server may employ alternative prompt sentence templates, including templates that switch languages, that specify domain terminology, or that request structured outputs such as tables. For example, the server may generate a prompt sentence such as:

“Summarize the following meeting content in Japanese. List the main topics as numbered items and the decisions as sub-items under each topic.”

In another variation, the server may embed control tokens or markers into the corrected character information in addition to the prompt sentence, and the generative AI model may be trained to interpret such control tokens as instructions for section boundaries or emphasis.

The terminal may be configured as a specialized conferencing device with dedicated audio processing hardware rather than a general-purpose smartphone or computer. In such an embodiment, the terminal may perform echo cancellation and noise suppression to improve the quality of audio information before transmission, thereby improving speech recognition accuracy and downstream processing.

The user may access summary information through different modalities, such as a voice interface generated by a text-to-speech engine. In such a case, the server may generate additional representations of summary information optimized for speech synthesis, such as shorter sentences or adjusted phrasing.

Through these embodiments and variations, the server, the terminal, and the user interact in a way that implements the claimed system. The described modules, data structures, and machine learning models provide a concrete technical framework that improves performance, accuracy, and efficiency of remote conferencing systems, and that goes beyond mere automation of human summarization by transforming how audio information is processed, stored, and presented in a computer environment.

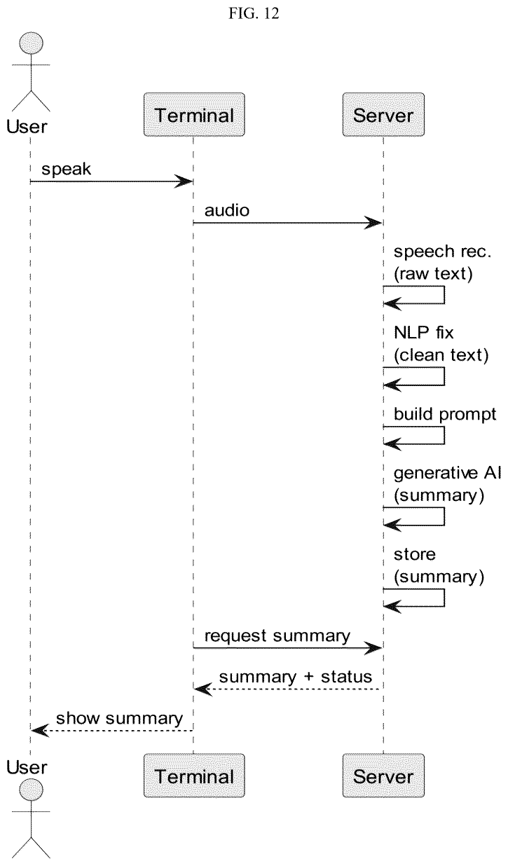

The following describes the processing flow using FIG. 12.
Step 1:

The terminal acquires audio information from a user.

The terminal uses a microphone to capture analog speech signals while the user participates in a remote conference. The input of this step is the analog acoustic waveform produced by the user and other participants. The terminal samples the waveform at a predetermined sampling rate and bit depth (for example, 16 kHz, 16-bit) and converts it into digital audio frames. The terminal segments the continuous stream into fixed-length frames (for example, 1-5 seconds), optionally applies compression or noise reduction, and encapsulates each frame with metadata such as meeting identifier and timestamp. The output of this step is a sequence of digital audio frames ready to be transmitted to the server.
Step 2:

The terminal transmits the digital audio frames to the server.

The terminal uses a network interface to send the audio frames over a communication path such as a wireless network. The input of this step is the sequence of digital audio frames and their associated metadata produced in Step 1. The terminal packages the frames into network packets or request bodies of an application protocol (for example, HTTPS) and adds headers including user identifier, meeting identifier, and format information. The terminal performs error checking, such as computing checksums, and then sends the requests to an endpoint address of the server. The output of this step is a set of network messages containing audio data that arrive at the server.
Step 3:

The server receives and stores the digital audio frames.

The server uses a network stack to accept the incoming requests from the terminal. The input of this step is the set of network messages containing the audio frames and metadata. The server reconstructs the original digital audio frames from the message payloads, validates the metadata, and writes the frames into a storage medium as audio segment records. The server assigns internal segment identifiers and records associations among segment identifiers, meeting identifiers, participant identifiers, and timestamps. The output of this step is a structured set of stored audio segments indexed by identifiers and time information.
Step 4:

The server converts the stored audio segments into character information by speech recognition processing.

The server uses a speech recognition interface module to process audio segments. The input of this step is the stored audio segments and their metadata produced in Step 3. The server extracts acoustic features from the audio, such as mel-frequency cepstral coefficients, and forwards either the raw audio or the extracted features to a speech recognition engine. The speech recognition engine applies an acoustic model and a language model to map the input features to sequences of tokens representing words or characters. The server receives the recognition result, parses it, and constructs transcript entries including recognized text and confidence scores. The output of this step is raw character information associated with each audio segment.
Step 5:

The server corrects the raw character information using a natural language processing technique implemented with a machine learning model.

The server uses a transcript correction module to refine the textual data. The input of this step is the raw character information produced in Step 4. The server tokenizes the raw text into sub-word units or word tokens, generates token identifiers, and feeds the sequence into a trained neural network model, such as a sequence-to-sequence transformer with attention. The model computes hidden representations for each token and predicts an improved token sequence that corrects grammar, inserts punctuation, normalizes spelling, and removes disfluencies. The server decodes the predicted token sequence back into text strings and attaches auxiliary tags such as sentence boundaries. The output of this step is corrected character information with enhanced grammatical and semantic quality.
Step 6:

The server constructs a prompt sentence that encodes summary generation conditions.

The server uses a summary generation module to build the control input for the generative AI model. The input of this step is the corrected character information produced in Step 5 and system-level summary requirements such as desired length or format. The server selects a template and fills variable fields with parameters, for example: “Please summarize the following remote meeting content in English. Focus on key decisions, action items, and dates. Output 3-5 concise bullet points.” The server concatenates this prompt sentence with the corrected character information, separated by delimiters, thereby forming a combined input sequence. The output of this step is a structured text input consisting of a prompt sentence and corresponding corrected character information.
Step 7:

The server generates summary information by supplying the prompt sentence and corrected character information to a generative AI model.

The server invokes a generative language model to perform controlled summarization. The input of this step is the combined text sequence produced in Step 6. The server encodes the input tokens into embeddings and processes them through the layers of a generative AI model, such as a transformer-based encoder-decoder network. The model calculates attention weights across tokens, builds contextual representations, and sequentially predicts output tokens according to the conditions specified in the prompt sentence. The server executes decoding with constraints on maximum token count or structure (for example, bullet list format). The output of this step is summary information text that concisely represents the essential content of the corrected character information.
Step 8:

The server aggregates multiple pieces of summary information into overall summary information.

The server uses the aggregation and storage module to construct higher-level summaries. The input of this step is a set of summary information texts produced in Step 7 for different time intervals or segments of a meeting. The server groups these summaries by meeting identifier and arranges them according to time information. The server may concatenate the summaries or transform them into a structured list and optionally supply them again to the generative AI model with a new prompt sentence that requests an overall summary. The server then receives and stores the resulting higher-level summary. The output of this step is overall summary information that covers an entire meeting or a large portion of the meeting.
Step 9:

The server stores summary information and overall summary information in association with time information.

The server writes the generated summary information and overall summary information into a database. The input of this step is the summary information and overall summary information produced in Steps 7 and 8, along with associated metadata including meeting identifiers, segment identifiers, and timestamps. The server constructs summary records and overall summary records that reference underlying transcript entries and time intervals. The server indexes these records by multiple keys to enable efficient retrieval by time range or topic. The output of this step is a persistent data set in the storage medium that maintains associations between summaries, transcripts, and temporal positions.
Step 10:

The server evaluates the progress state of the meeting based on stored summary information.

The server uses the meeting progress evaluation module to interpret the content of summaries. The input of this step is the stored summary information and overall summary information produced in Step 9. The server scans summary texts for patterns indicating that agenda items have been introduced, discussed, or concluded, and updates internal counters representing coverage of each item. The server applies decision rules or a trained classifier to compute an evaluation result, such as a completion percentage or a categorical progress state. The output of this step is a meeting progress evaluation result associated with the meeting and specific time intervals.
Step 11:

The server distributes summary information and progress evaluation results to the terminal.

The server responds to requests from the terminal by sending relevant data. The input of this step is a retrieval request from the terminal specifying a meeting identifier or time segment, and the stored data produced in Steps 9 and 10. The server selects corresponding summary information, overall summary information, and evaluation results, formats them into response messages, and transmits them via the communication path. The output of this step is a set of network responses containing textual summaries and progress indicators delivered to the terminal.
Step 12:

The terminal displays the summary information and progress evaluation results to the user.

The terminal uses the display and interaction module to render content on its display. The input of this step is the network responses received from the server in Step 11. The terminal parses the messages, extracts summary text, overall summary text, and progress metrics, and arranges them in a user interface layout, such as a list of bullet points with associated progress bars. The terminal maps user interface elements to underlying time intervals so that the user can navigate. The output of this step is a visual presentation on the display that allows the user to quickly understand the main points and current state of the meeting.
Step 13:

The user interacts with the terminal to navigate and refine viewing of meeting information.

The user provides inputs such as taps, clicks, or scroll gestures on the terminal screen. The input of this step is the user's interaction with displayed summary information and progress indicators. The terminal detects these interactions and generates control commands, such as a request to expand a particular summary item, to view corresponding corrected transcript text, or to jump to an associated time interval. The terminal transmits such requests back to the server when needed. The output of this step is a sequence of control messages and local display updates that provide the user with detailed views tied to specific parts of the meeting.
Step 14:

The server and terminal iteratively update summaries and displays during the meeting.

The server continuously processes new audio segments and generates updated summary information as the meeting progresses. The input of this step on the server side is the newly arriving audio and previously stored internal state. The server repeats Steps 3 through 8 on the new data and updates stored records. The terminal periodically requests or receives push notifications containing fresh summary information and evaluation results. The output of this step is an evolving set of summaries and progress indicators that are reflected on the terminal in near real time, enabling the user to follow the meeting efficiently without processing the entire audio or full transcript manually.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In contemporary communication environments, large volumes of audio information such as remote conferences, voice messages, and recorded discussions are generated and transmitted over networks. Conventional computer systems that convert such audio data into text typically rely on isolated speech recognition engines and static natural language processing modules. These conventional systems often produce transcripts containing grammatical errors, semantic inconsistencies, and domain-specific misrecognitions, and provide only limited or no automated summarization. As a result, users are forced to manually correct and condense long transcripts, which leads to increased processing latency, higher cognitive load, and inefficient utilization of computing resources.

Furthermore, in many existing architectures, the text correction and summarization processes are not integrated with generative models through explicit prompt sentences. Instead, rigid rule-based pipelines or narrowly configured models are used, which cannot flexibly adapt to different summarization conditions, user editing behavior, or streaming audio scenarios. This results in suboptimal use of advanced machine learning capabilities: the system cannot dynamically refine prompts based on user feedback, cannot incrementally update corrected text and summaries in near real time as audio is received, and cannot provide responsive, interactive text services over communication networks.

From a computer technology standpoint, there is a need for improved mechanisms within a server-side processor to (i) coordinate speech-to-text conversion, error-aware natural language correction, and generative model-based summarization, (ii) generate and update prompt sentences that encode summarization conditions for a generative artificial intelligence model, and (iii) handle incremental processing of streaming audio segments while synchronizing with a remote information terminal device. Without such mechanisms, the server cannot efficiently manage computation across heterogeneous models, cannot reduce network and processing overhead for long-running sessions, and cannot provide users with timely, high-quality text outputs that reflect both automatic processing and user edits.

Accordingly, there is a need for a computer-implemented system that improves the functioning of the server and its processor by tightly integrating audio acquisition, text conversion, adaptive prompt generation, generative artificial intelligence-based summarization, and interactive update handling. Such a system should be capable of incrementally producing corrected and summarized character information, transmitting it over a communication network, and regenerating summaries in response to user edits, thereby enhancing processing efficiency, responsiveness, and accuracy beyond that of conventional speech transcription and summarization solutions.

The specific processing by the specific processing unit 290 of the data processing device 12 in Example 2 is realized by the following means.

The present invention provides a server comprising a processor configured to acquire audio information and convert the audio information into character information, to correct the character information grammatically and semantically and to detect and correct errors in the character information by using natural language processing techniques including a machine learning model, to generate, based on corrected character information, a prompt sentence including summarization conditions and to input the prompt sentence and the corrected character information into a generative artificial intelligence model to generate summarized character information, to transmit the character information, the corrected character information, and the summarized character information to an information terminal device via a communication network and cause the information terminal device to display the character information, the corrected character information, and the summarized character information, to receive, from the information terminal device, edit content by a user with respect to at least one of the corrected character information and the summarized character information and, based on the edit content, to update the summarization conditions and input an updated prompt sentence for regeneration into the generative artificial intelligence model to regenerate the summarized character information, and to divide the audio information into a plurality of time units, sequentially generate the character information for each of the time units, apply the natural language processing techniques and the generative artificial intelligence model to the character information generated for each of the time units to incrementally update the corrected character information and the summarized character information, and sequentially transmit update results to the information terminal device. This enables an improvement in computer functionality by allowing the server to orchestrate speech recognition, error-aware natural language correction, and prompt-driven generative summarization in an integrated and incremental manner, thereby reducing processing latency, optimizing use of computational resources, supporting interactive regeneration of summaries based on user edits, and providing more accurate and timely text outputs for audio information transmitted over communication networks.

The term “audio information” refers to information representing sound captured from a sound source, including a human voice, and encoded in a digital format suitable for processing by a computing device.

The term “character information” refers to information representing text encoded as a sequence of characters or symbols that can be stored, processed, and displayed by a computing device.

The term “corrected character information” refers to character information obtained by processing character information to detect and correct errors including grammatical errors, semantic inconsistencies, spelling mistakes, and typographical errors.

The term “summarized character information” refers to character information representing a condensed form of other character information, the condensed form preserving at least key points, important items, or essential meaning of the other character information.

The term “natural language processing techniques” refers to computational techniques for analyzing, interpreting, generating, or transforming human languages, including tokenization, parsing, error detection, error correction, and summarization.

The term “machine learning model” refers to a computational model trained on data to learn patterns and perform tasks such as prediction, classification, transformation, or generation of data without being explicitly programmed with task-specific rules.

The term “generative artificial intelligence model” refers to a machine learning model configured to generate new data, including text, in response to input data and instructions, based on patterns learned from training data.

The term “prompt sentence” refers to a sequence of words or symbols provided as an instruction or query to a generative artificial intelligence model to specify a task, such as summarization, correction, or transformation, to be performed on input data.

The term “summarization conditions” refers to parameters or constraints included in or associated with a prompt sentence, the parameters or constraints specifying how summarization is to be performed, including at least length, format, focus, or level of detail of a summary.

The term “information terminal device” refers to an electronic device operated by a user that is configured to communicate with a server via a communication network and to present character information, including corrected character information and summarized character information, to the user.

The term “communication network” refers to any wired or wireless infrastructure that enables data transmission between a server and at least one information terminal device, including local area networks, wide area networks, and public networks.

The term “edit content” refers to information representing changes made by a user to at least part of character information, corrected character information, or summarized character information, including insertion, deletion, or modification of characters or segments.

The term “time unit” refers to a segment of audio information defined by a duration or similar temporal criterion and used as a unit for sequential or incremental processing of the audio information.

The term “update result” refers to information representing at least one of newly generated or modified corrected character information and summarized character information that is produced after processing and transmitted from a server to an information terminal device.

In one embodiment, a server cooperates with at least one terminal operated by a user to implement the claimed system in a networked environment. The server includes at least one processor, a main memory, a non-volatile storage device, and a network interface. The processor may be realized by a central processing unit and, in some embodiments, by a graphics processing unit configured for parallel numerical computation. The terminal includes an input/output interface, a microphone, a display, a user input device, and a communication interface. The user operates the terminal to capture audio information and to view character information supplied from the server.

The server executes a program stored in the non-volatile storage device and loaded into the main memory. The program defines software modules including an audio reception module, a speech-to-text module, a natural language correction module, a generative summarization module, a prompt management module, a user-edit processing module, and a communication control module. Each module is implemented, for example, using an application framework such as a server-side runtime environment, and may interface with external machine learning libraries and models.

The server receives audio information from the terminal through the communication control module. The terminal uses microphone hardware and an operating system audio interface to convert an analog voice signal into digitized audio data, such as pulse code modulated samples at a predetermined sampling rate. The terminal sends the audio data to the server via a communication network using a protocol such as Hypertext Transfer Protocol Secure or a persistent bidirectional protocol.

The server stores the received audio information in a structured data store. In one example, the server stores, for each session, a record including a session identifier, a user identifier, a language code, and a pointer to an audio file or audio buffer. The server uses an audio processing library to normalize the sampling rate, channel configuration, and encoding format of the audio information. The server optionally reduces environmental noise and performs silence detection. Because the server enforces a normalized audio format and noise reduction at this stage, subsequent speech-to-text processing is executed under stable input conditions, which improves recognition accuracy and reduces the number of correction operations required downstream.

The server converts the normalized audio information into character information by executing the speech-to-text module. In one implementation, the speech-to-text module uses a probabilistic acoustic model and a language model trained in advance. The acoustic model may be implemented as a deep neural network with multiple hidden layers that receives as input acoustic feature vectors such as Mel-frequency cepstral coefficients or log-Mel filter bank energies. The language model may be implemented as an n-gram model or a neural sequence model that estimates the probability of word sequences. The server combines outputs from the acoustic model and the language model using a decoding algorithm, such as a beam search decoder, to determine the most probable sequence of words.

The server outputs the sequence of words as character information and associates each word with a timestamp and a confidence score. The server stores the character information in a data structure such as a list or table, where each entry includes at least a token string, a position index, a confidence value, and time alignment data. This structured storage allows the server to later apply corrections selectively to low-confidence regions and to align summarized character information with portions of the original audio information. The server thus improves data management inside the computer system and enables subsequent modules to operate with reduced redundancy.

The server corrects the character information grammatically and semantically by executing the natural language correction module. In one embodiment, the server uses a machine learning model implemented as a transformer-based neural network. The server tokenizes the character information into subword units using a tokenizer algorithm, maps the subword units to integer identifiers, and constructs input tensors. The server inputs the tensors to the transformer-based model that includes a plurality of self-attention layers, feed-forward layers, and normalization layers. The model has been trained on large parallel corpora of erroneous and corrected text using a loss function such as a cross-entropy loss between predicted tokens and reference tokens. During training, the server or an external training system has updated model weights using an optimization algorithm such as stochastic gradient descent with adaptive moment estimation and has optionally applied data augmentation strategies, such as random noise injection into input sequences, to improve robustness.

During inference in the deployed system, the server computes contextual representations for each token in the character information and estimates, for each token position, a probability distribution over possible output tokens. The server selects, according to a decision rule such as maximum probability or top-k sampling with constraints, a corrected token sequence. The server compares the corrected token sequence with the original token sequence to identify positions where substitutions, insertions, or deletions occur. The server records a mapping between original token indices and corrected token indices. This mapping allows the server to maintain alignment between recognized speech segments and corrected character information, thereby improving technical handling of subsequent processing and display on the terminal.

The server stores the corrected character information as a separate data field. The server may also apply rule-based post-processing, such as normalization of whitespace, standardization of punctuation symbols, or application of domain-specific abbreviation rules. These rule-based procedures are defined as deterministic algorithms and represent non-conventional steps configured to operate on the machine-generated text structures, such as applying regular expressions targeting tokens with a confidence score below a specified threshold. These operations reduce systematic transcription errors that are typical in audio-to-text workflows and achieve a lower residual error rate compared with manual correction, thereby improving overall system accuracy and throughput.

The server generates summarized character information by executing the generative summarization module in cooperation with the prompt management module. The server constructs a prompt sentence that encodes a summarization task and summarization conditions. The server may use, for example, a prompt sentence in natural language such as:

“Summarize the following meeting transcript in a concise form, keeping all key decisions and action items. Transcript: [corrected text].”

The server may additionally use:

“First correct any spelling and grammatical errors in the following text, then provide a concise summary of no more than 150 words. Text: [raw transcript text].”

The server may use a language-specific prompt sentence such as:

“Please correct the typo in the following sentence: It's fine weather today” and may apply a summarized version after correction such as:

“Summarize the following corrected Japanese text in three bullet points. Text: [corrected Japanese text].”

The server encodes the summarization conditions in machine-readable form, for example by maintaining, for each session, parameters specifying maximum summary length, output style, language, and priority topics. The server inserts these conditions into the prompt sentence according to template rules managed by the prompt management module. By representing summarization conditions explicitly in prompt sentences and parameter structures, the server controls behavior of the generative artificial intelligence model in a systematic and repeatable manner, rather than relying on opaque general instructions.

The server inputs the prompt sentence and the corrected character information to a generative artificial intelligence model. In one embodiment, the model is implemented as a sequence-to-sequence transformer network with an encoder and a decoder. The encoder receives tokenized corrected character information and the decoder generates a summary sequence conditioned on both the encoder outputs and the prompt sentence. The server uses deterministic or constrained decoding algorithms, such as beam search with a coverage penalty or nucleus sampling with a low sampling threshold, to generate summarized character information that satisfies the summarization conditions. The server may enforce additional algorithmic constraints during decoding, such as limiting repetition or enforcing inclusion of tokens corresponding to specific keywords. These constraints are implemented as modifications to token selection probabilities at each decoding step.

The server stores the summarized character information and maintains an association between segments of the corrected character information and corresponding segments of the summarized character information using index mapping structures. This association is useful when the user scrolls through the summary on the terminal and requests playback of the corresponding audio information. Because the server maintains these index structures automatically, the system reduces manual mapping and enables efficient synchronization between audio, full transcript, and summary.

The server transmits the character information, the corrected character information, and the summarized character information to the terminal via the communication control module. The server packages these data items into structured messages including identifiers, time stamps, and content fields. The terminal receives the messages and displays the information on a screen. The user can view a full corrected transcript in one region of the display and a concise summary in another region. The terminal may highlight portions of the corrected character information that correspond to summary items, using the index mapping supplied by the server, thereby making use of the structured technical data provided by the system.

The user can edit at least part of the corrected character information or the summarized character information using input means on the terminal. The terminal captures user edits as edit content and sends the edit content back to the server together with identifiers indicating which session and which portion of text has been edited. The server receives the edit content and updates the stored corrected character information and summarized character information accordingly. The server analyzes the edit content to detect patterns in user corrections, such as frequently revised terminology or specific stylistic preferences. The server updates summarization conditions based on these detected patterns, for example by increasing weighting of certain keywords or by adjusting permitted summary length. The server constructs an updated prompt sentence that reflects the modified summarization conditions and re-inputs the updated prompt sentence and revised text to the generative artificial intelligence model. By performing this feedback loop in the server processor, the system uses the user's edits not only as final outputs but as signals to reconfigure internal model-driven processing, which improves adaptability and personalization without requiring repeated full manual intervention.

In another embodiment, the server divides the audio information into a plurality of time units. The server maintains a queue of audio segments, each segment corresponding to a fixed duration window. For each time unit, the server performs speech-to-text conversion, natural language correction, and generative summarization as described above. The server incrementally updates the corrected character information and summarized character information as new time units are processed. The server transmits update results to the terminal as they become available. This incremental processing architecture reduces perceived latency for the user because the user can see an evolving transcript and summary during an ongoing remote conference. From a technical standpoint, the server reduces computation peaks by distributing processing over time and can reuse hidden state representations for overlapping context windows, improving computational efficiency and resource utilization within the processor and memory subsystem.

The server can implement alternative machine learning models in the natural language correction module and the generative summarization module. In one variant, the server uses a bidirectional encoder model for correction and a separate encoder-decoder model for summarization. In another variant, the server uses a unified model that performs joint correction and summarization by conditioning the decoder on a task identifier embedded in the prompt sentence. The server can configure model hyperparameters, such as number of layers, attention heads, hidden dimension size, dropout rates, and learning rate schedules, to balance accuracy and computational cost. The server may also employ quantization or pruning techniques to compress model weights and to reduce inference latency, thereby improving throughput on resource-constrained hardware.

The server can deploy additional algorithms for managing internal data flow. For example, the server can maintain a sliding window index structure that links time units of audio information to segments of character information and summarized character information. The server can apply a chunking algorithm that splits long corrected character information into semantically coherent segments based on punctuation and discourse markers. These structured segmentation and indexing steps are not conventional manual procedures but are specific to the computer implementation, enabling the generative artificial intelligence model to operate on bounded context segments and reducing memory consumption and processing time.

The server improves computer technology by integrating these modules and data structures in a coordinated way. Because the server performs correction and summarization based on explicit prompt sentences and structured conditions, and because the server maintains alignment mappings and incremental update mechanisms, the system reduces redundant recalculation of entire transcripts when only a part is edited or appended. The system can recompute summaries for affected segments while reusing existing results for unchanged segments, which reduces processor cycles and network bandwidth. Moreover, the use of explicit confidence scores and structural indices allows the server to prioritize recalculation of low-confidence or heavily edited regions, thereby improving average quality of outputs per unit of computational effort.

The server's operation is not limited to mere automation of human reading and summarization. The server uses internal numerical representations, attention weights, error gradients, and confidence metrics that are not accessible to a human operator. The server updates these internal parameters based on large-scale statistical patterns learned during training, resulting in non-intuitive correction and summarization behaviors that arise from complex neural network architectures. The ability to exploit such internal representations, combined with explicit algorithmic management of prompts, time-unit processing, and index mapping, yields technical effects in the form of higher transcription accuracy, faster summary generation, improved synchronization between audio and text, and reduced communication overhead between the server and the terminal.

In yet another embodiment, the server can support multiple terminals in parallel, where each terminal requests character information and summarized character information for a different session. The server schedules processing tasks across processor cores and accelerators using a task queue and a load balancing algorithm. By managing model inference requests, audio normalization tasks, and summarization generation jobs as separate but coordinated tasks, the server achieves improved scalability and robustness for large numbers of concurrent sessions. The server can cache intermediate model outputs and reuse them across related requests, further decreasing processing time.

Through these embodiments and variations, the server, the terminal, and the user cooperate to implement the claimed system. The server executes concrete data processing algorithms grounded in specific hardware and software modules, uses defined data structures and prompt sentences, and thereby provides a technical improvement to computer-implemented handling of audio information, character information, corrected character information, and summarized character information over communication networks.

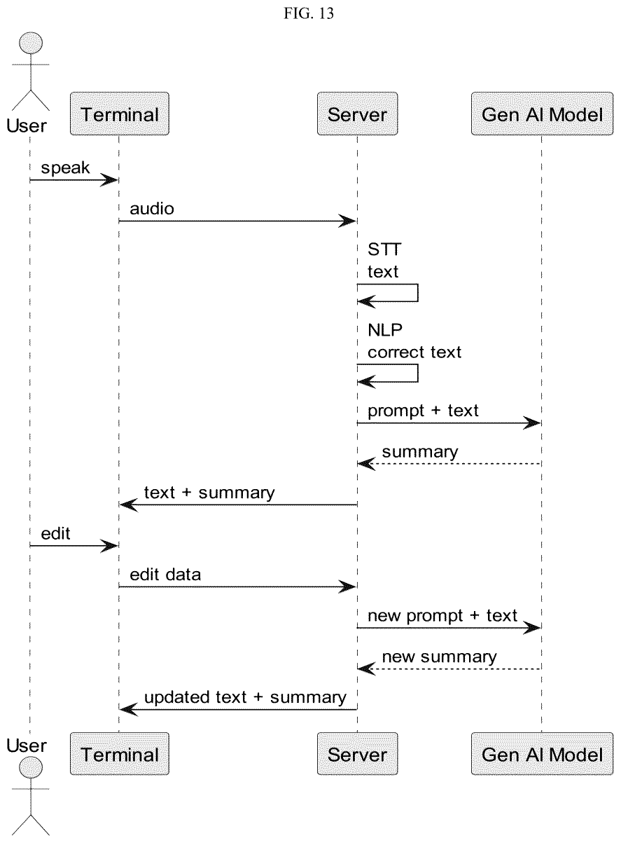

The following describes the processing flow using FIG. 13.
Step 1:

User operates the terminal to capture audio information. The terminal receives, as input, an analog voice signal from a microphone. The terminal converts the analog signal into digital audio data by using an operating system audio interface, which samples the signal at a predetermined sampling rate and quantizes the samples to a fixed bit depth. The terminal stores the resulting audio frames in a buffer and attaches metadata such as a session identifier, a language code, and timestamps. The terminal outputs structured audio information ready to be transmitted to the server.
Step 2:

Terminal transmits the audio information to the server. The terminal receives, as input, the buffered audio information and associated metadata from Step 1. The terminal opens a secure communication channel to the server and encapsulates the audio information and metadata into a network message. The terminal performs data formatting, such as encoding the metadata in a text header and appending the binary audio payload. The terminal outputs a network packet stream containing the audio information and metadata to the server.
Step 3:

Server receives and normalizes the audio information. The server receives, as input, the network packet stream from the terminal. The server reconstructs the audio information by reassembling the packets and extracting the metadata. The server then applies an audio processing procedure that resamples the audio to a target sampling rate, converts the number of channels (for example, to mono), and normalizes amplitude. The server optionally performs noise reduction and silence trimming using digital filters and energy-based thresholding. The server outputs normalized audio data and an updated metadata record.
Step 4:

Server converts the normalized audio information into character information. The server receives, as input, the normalized audio data and metadata from Step 3. The server extracts acoustic features, such as Mel-frequency cepstral coefficients, by applying a short-time Fourier transform and a filter bank to the audio frames. The server feeds the acoustic features into a speech recognition model that computes, for each time frame, probabilities of phonetic or subword units. The server applies a decoding algorithm that combines these probabilities with a language model to determine the most probable sequence of tokens. The server outputs character information as a token sequence with associated timestamps and confidence scores.
Step 5:

Server structures and stores the character information. The server receives, as input, the token sequence, timestamps, and confidence scores from Step 4. The server constructs a data structure, such as a list of records, where each record contains at least one token string, a position index, a start time, an end time, and a confidence value. The server writes this data structure into a storage subsystem and associates it with the session identifier. The server outputs a reference to the stored character information and a consolidated text string representing the initial transcript.
Step 6:

Server performs natural language correction on the character information. The server receives, as input, the consolidated text string and the structured token records from Step 5. The server tokenizes the text string into subword units and maps each unit to an integer identifier. The server passes the sequence of identifiers to a transformer-based machine learning model, which computes contextual embeddings and, for each position, a probability distribution over possible output tokens. The server selects corrected tokens based on the highest probabilities and reconstructs a corrected text sequence. The server also computes a difference between the original and corrected sequences to identify insertions, deletions, and substitutions. The server outputs corrected character information and an alignment mapping between original and corrected tokens.
Step 7:

Server applies rule-based post-processing to the corrected character information. The server receives, as input, the corrected character information and the alignment mapping from Step 6. The server scans the corrected text for patterns such as repeated spaces, inconsistent punctuation, or domain-specific abbreviations. The server applies deterministic rules, such as replacing multiple spaces with a single space, normalizing quotation marks, and expanding or standardizing abbreviations. The server modifies the corrected character information according to these rules while preserving the alignment mapping where possible. The server outputs normalized corrected character information suitable for summarization.
Step 8:

Server constructs a prompt sentence including summarization conditions. The server receives, as input, the normalized corrected character information and session-specific parameters such as desired summary length, output language, and format preferences. The server generates a prompt sentence in natural language that encodes the summarization task and conditions, for example: “Summarize the following meeting transcript in a concise form, keeping all key decisions and action items. Transcript: [corrected text].” The server combines the prompt template with the corrected text and condition parameters. The server outputs a complete prompt sentence and a set of machine-readable summarization condition values.
Step 9:

Server generates summarized character information using a generative AI model. The server receives, as input, the prompt sentence and the normalized corrected character information from Step 8. The server tokenizes the prompt sentence and the corrected text, concatenates their token sequences according to a predefined format, and feeds the resulting sequence into a generative AI model. The model encodes the input and generates output tokens one by one while the server executes a decoding algorithm that respects the summarization conditions, such as limiting the number of tokens and discouraging repetition. The server converts the generated tokens into a summary string. The server outputs summarized character information and, optionally, internal mapping data linking summary segments to corresponding segments in the corrected text.
Step 10:

Server stores and associates the summarized character information. The server receives, as input, the summarized character information and any mapping data from Step 9. The server creates a summary record that includes the summary string, the session identifier, summarization condition parameters, and references to the corresponding corrected text segments. The server writes this record to persistent storage and updates the session status to indicate that summary generation is complete. The server outputs identifiers and references that allow later retrieval of the summary along with the corrected character information.
Step 11:

Server transmits character information, corrected character information, and summarized character information to the terminal. The server receives, as input, the identifiers and references from Step 10, as well as the stored character information and corrected character information from earlier steps. The server constructs a response message that includes at least the initial transcript text, the corrected text, and the summary text, together with metadata such as timestamps and mapping indices. The server serializes this response message into a network format and sends it through the communication network to the terminal. The server outputs a transmitted response that the terminal can parse and display.
Step 12:

Terminal receives and displays the transmitted information. The terminal receives, as input, the response message from Step 11. The terminal parses the message to extract the initial transcript, the corrected transcript, and the summary. The terminal allocates display regions, for example one region for the corrected transcript and another region for the summary, and renders the text using a graphical user interface. The terminal may use the mapping indices to highlight parts of the corrected transcript when a corresponding part of the summary is selected. The terminal outputs a visual representation of the character information for the user.
Step 13:

User edits the corrected or summarized character information on the terminal. The user receives, as input, the displayed corrected transcript and summary from Step 12. The user operates input devices on the terminal, such as a keyboard or touch panel, to modify words, insert missing information, or delete unwanted portions in the corrected text or the summary. The terminal records these modifications as edit content, including original text, new text, and positions. The terminal outputs a structured edit record representing the user's modifications.
Step 14:

Terminal transmits the edit content to the server. The terminal receives, as input, the structured edit record from Step 13. The terminal associates the edit record with the session identifier and the specific text segment identifiers and converts the record into a transmission format. The terminal sends the edit content to the server through the communication network. The terminal outputs a network request that instructs the server to update internal text data.
Step 15:

Server updates internal text data based on the edit content. The server receives, as input, the edit content and the session identifier from Step 14. The server locates the corresponding corrected character information and summarized character information in storage. The server applies the edit operations to the stored corrected text, updating specific segments according to insertion, deletion, or replacement instructions. The server adjusts alignment mappings and summary-to-text mappings to reflect the new text content. The server outputs updated corrected character information and updated mapping data.
Step 16:

Server regenerates summarized character information using an updated prompt sentence. The server receives, as input, the updated corrected character information and the edit content from Step 15. The server analyzes the edit content to derive new summarization conditions, such as emphasizing certain terms or adjusting summary length. The server constructs an updated prompt sentence that incorporates the new conditions, for example: “Summarize the following revised transcript in no more than 150 words, emphasizing action items. Transcript: [revised corrected text].” The server feeds the updated prompt sentence and revised corrected text into the generative AI model, performs tokenization and decoding as before, and generates a new summary string. The server outputs regenerated summarized character information that reflects the user's edits.
Step 17:

Server transmits updated results to the terminal. The server receives, as input, the regenerated summarized character information and the updated corrected character information from Step 16. The server packages these updated texts and associated metadata into a response message that indicates an update rather than an initial generation. The server sends this response message to the terminal over the communication network. The server outputs an updated result that allows the terminal to refresh the displayed content.
Step 18:

Terminal refreshes the display with updated corrected and summarized character information. The terminal receives, as input, the updated result from Step 17. The terminal parses the message and replaces the displayed corrected transcript and summary with their updated versions, while maintaining the user's viewing context where possible. The terminal may animate or highlight changed regions using the mapping data to draw the user's attention to updated content. The terminal outputs a refreshed visual display that presents the latest corrected and summarized character information to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented speech processing systems typically perform only isolated functions such as speech-to-text conversion, text-only summarization, or standalone sentiment analysis. In many architectures, these functions are executed in separate components that do not share intermediate representations or contextual information. As a result, the overall pipeline tends to suffer from accumulated errors, inconsistent interpretations, and high latency. For example, errors introduced at the speech recognition stage are often propagated into downstream summarization or analytics, leading to misleading summaries and unreliable emotion analysis.

Furthermore, many existing systems treat user input correction, summarization, and emotion analysis as independent application-level features rather than as integrated improvements to the underlying data processing pipeline. Input normalization is frequently performed only at the user interface level, without leveraging deep language models or prompt-based generative models. Emotion analysis is often based solely on either acoustic features or text sentiment, not on a fused representation of both. This fragmented design leads to suboptimal utilization of computing resources, reduced robustness against noisy input, and limited adaptability of system behavior to user state.

In addition, typical architectures for meeting support, electronic payment, or interactive assistance lack a unified mechanism for: (i) dynamically generating prompt sentences for a generative AI model according to the system context; (ii) feeding corrected and normalized text into that model; and (iii) feeding back the generated summary and emotion analysis to drive subsequent computational actions such as anomaly detection, alert generation, and content recommendation. Consequently, the computer system cannot reliably provide low-latency, context-aware processing that improves both the quality of machine-generated outputs and the efficiency of subsequent machine operations such as transaction processing or real-time display control.

There is therefore a need for an improved computer system and processing architecture in which a processor cooperatively performs speech acquisition, speech-to-text conversion, grammatical and semantic correction, prompt-driven interaction with a generative AI model, multimodal emotion analysis based on both acoustic characteristics and linguistic content, and automated downstream actions such as anomaly detection, notification, recommendation, and control of external devices. Such a system should improve the accuracy, robustness, and responsiveness of the overall computing pipeline itself, rather than merely adding application-layer features.

The specific processing by the specific processing unit 290 of the data processing device 12 in Application Example 2 is realized by the following means.

The present invention provides a server comprising a processor configured to acquire audio information and convert the audio information into character information, to correct the character information grammatically and semantically by using natural language processing technology so as to normalize user input information including erroneous input, to generate a prompt sentence that instructs generation of a summary or an explanation based on the corrected character information or the normalized user input information and to input the prompt sentence and the character information into a generative AI model to generate summary information, to estimate an emotional state based on acoustic characteristics of the audio information, to estimate an emotional state based on linguistic content of the character information and to integrate the emotional state based on the linguistic content with the emotional state based on the acoustic characteristics to generate an emotion analysis result, to detect an abnormal emotional change based on the emotion analysis result and to generate notification information, to recommend related information based on at least one of the emotion analysis result and the abnormal emotional change, and to output at least part of the summary information, the normalized user input information, the emotion analysis result, the notification information, and the related information to an external apparatus. This enables an integrated, computer-implemented processing pipeline in which the server itself improves the quality and reliability of downstream computations by providing corrected and normalized text, context-sensitive prompt sentences for a generative AI model, fused multimodal emotion analysis, and automated control outputs, thereby reducing error propagation, enhancing robustness to noisy input, and improving the overall efficiency and responsiveness of the speech and text processing functions executed by the computer system.

The term “audio information” refers to information representing sound as an analog or digital signal, including speech captured from a human speaker, that is suitable for processing by an information processing apparatus.

The term “character information” refers to information in which content of audio information or user input is expressed as a sequence of characters or symbols in a textual format that can be processed by a natural language processing algorithm.

The term “user input information” refers to information that is directly or indirectly provided by a human user to a computing system, including spoken utterances, typed text, selection operations, or other interaction data, and including erroneous or incomplete input.

The term “natural language processing technology” refers to a collection of algorithms and models by which a computing system analyzes, interprets, generates, or transforms human language represented as text, including but not limited to tokenization, parsing, grammatical correction, semantic analysis, and summarization.

The term “grammatically and semantically correct” refers to a state of character information in which linguistic expressions conform to syntactic rules of a target language and convey intended meaning in a coherent and contextually appropriate manner.

The term “normalize” refers to a process of transforming user input information into a standardized form, including correction of typographical errors, unification of orthography or notation, resolution of inconsistent expressions, and adjustment to a canonical representation required by a downstream process.

The term “prompt sentence” refers to a sequence of characters that provides instructions or context to a generative AI model, specifying a task such as summarization, explanation, correction, or analysis to be performed by the model.

The term “generative AI model” refers to a computational model based on machine learning, typically including a neural network trained on large-scale data, that is configured to generate new data such as text in response to input information including a prompt sentence.

The term “summary information” refers to information that is shorter than corresponding source information and that represents essential points, key facts, or main ideas extracted or generated from the source information.

The term “acoustic characteristics” refers to measurable properties of audio information, including but not limited to fundamental frequency, energy, loudness, spectral distribution, and temporal rate, which can be extracted and analyzed by a computing system.

The term “linguistic content” refers to semantic and syntactic information conveyed by character information, including words, phrases, sentence structure, and context, which expresses the meaning of human language.

The term “emotional state” refers to a condition associated with affective aspects of a speaker, such as joy, sadness, anger, fear, fatigue, or degrees thereof, estimated by analyzing audio information and/or character information.

The term “emotion analysis result” refers to information indicating one or more estimated emotional states of a speaker, optionally including confidence values, intensity values, temporal positions, or categories derived from acoustic characteristics and linguistic content.

The term “abnormal emotional change” refers to a variation in the emotion analysis result that deviates from a predetermined reference pattern or threshold, such as a sudden increase or decrease in intensity of a particular emotional state or a sustained atypical emotional pattern.

The term “notification information” refers to information generated by a computing system for the purpose of informing a user or another system about an event, condition, or abnormal emotional change, and may include an alert, warning, message, or control signal.

The term “related information” refers to information selected or generated based on at least one of an emotion analysis result or an abnormal emotional change, including but not limited to recommended content, guidance, or actions that are determined to be relevant to the user's state or context.

The term “external apparatus” refers to a device or system that is distinct from a server executing the processor functions and that is configured to receive at least part of the outputs from the server, such as a display device, terminal device, or transaction processing system.

The term “visual display apparatus” refers to an external apparatus configured to present information in visual form to a user, including but not limited to a monitor, a mobile device display, a head-mounted display, or smart glasses.

The term “conference” refers to a communication session in which two or more participants exchange information, typically through audio or audiovisual channels, and which may be conducted in a remote or local environment.

The term “settlement information” refers to normalized user input information used for execution of an electronic transaction, including data such as account identifiers, payment amounts, payer information, payee information, and other attributes required by a transaction processing system.

The term “electronic transaction processing” refers to processing performed by a computing system to execute a commercial or financial transaction using electronic data, including validation of settlement information, authorization, recording of transaction details, and generation of a transaction result.

In one embodiment, a server cooperates with one or more terminals operated by a user to implement the claimed system. The server includes a processor, a main memory, a non-volatile storage device, a network interface, and optionally a hardware accelerator such as a graphics processing unit or a tensor processing unit. The terminal includes a processor, a memory, a microphone, a visual display apparatus, and a communication interface such as a wireless network interface. The terminal may be implemented as a smartphone, a tablet, a personal computer, or a head-mounted display such as smart glasses.

The server stores, in the non-volatile storage device, program modules including an audio acquisition module, a speech-to-text module, a natural language processing module, a prompt generation module, a generative AI interaction module, an acoustic feature extraction module, an emotion fusion module, an abnormality detection module, a recommendation module, and an external apparatus control module. The server loads these modules into the main memory and executes the modules by the processor so as to implement the functions recited in the claims.

The terminal captures audio information by using the microphone and an operating system-level audio driver. The terminal digitizes the audio information as pulse code modulation data having a predetermined sampling frequency and bit depth, and the terminal segments the audio information into frames of fixed length. The terminal packages the frames with metadata such as sampling rate, language code, and session identifier, and the terminal transmits the packaged audio information to the server by using a transport protocol over a communication network.

The server receives the audio information through the network interface and buffers the audio information in a circular buffer in the main memory. The server then converts the audio information into character information. In one embodiment, the server invokes a speech recognition engine implemented as a remote speech-to-text service. The server transmits the buffered audio frames to the speech recognition engine by using an application programming interface and receives transcription results including text hypotheses and confidence scores for each segment. The server stores the received character information in a structured data store, such as a relational database table in which each record includes a session identifier, a time index, the recognized text, and the confidence scores.

The server corrects the character information grammatically and semantically by using natural language processing technology. In one embodiment, the server loads a transformer-based language model that has an encoder architecture with multiple self-attention layers and feed-forward networks. The server tokenizes the character information into subword tokens by using a deterministic tokenizer and converts the tokens into numerical identifiers. The server feeds the numerical identifiers into the encoder layers and computes contextualized representations for each token by using multi-head self-attention, layer normalization, and residual connections. The server then applies a prediction head that outputs, for each token position, a probability distribution over candidate corrected tokens. The server selects the most probable corrected token at each position, or applies a beam search strategy to maximize a global likelihood, and reconstructs corrected character information. The server thereby normalizes user input information including erroneous input such as typographical errors, misrecognized words, and inconsistent orthography.

The server further applies rule-based post-processing to the corrected character information. The server maintains a normalization dictionary and grammar rules generated from domain-specific training data. The server performs substitution of domain-specific terms, expansion of abbreviations, and normalization of numeric expressions according to the normalization dictionary. The server also applies syntactic constraints derived from a dependency parser to avoid corrections that would violate grammatical structures. This combination of learned model output and deterministic rules improves correction accuracy and reduces error propagation from the speech-to-text module into downstream processing.

The server generates a prompt sentence to interact with a generative AI model. The server determines, based on a processing context indicator stored in the database, whether a task is summarization, explanation, or other text generation. For a summarization task of a conference transcript, the server generates a prompt sentence such as:

“Please summarize the following meeting transcript focusing on key decisions, action items, and deadlines:”

and concatenates the corrected character information corresponding to a time interval of the conference. For a normalization or explanation task of user address input, the server generates a prompt sentence such as:

“Please normalize and correct the following address: Tokyo”

For an emotion-related explanation, the server generates a prompt sentence such as:

“Analyze the following text and describe the speaker's likely emotion: This project is very important.”

The server constructs the prompt sentence and the task-specific text into an input sequence compatible with the generative AI model, including special tokens for start and end of sequence and, if applicable, section delimiters for multiple speakers.

The server communicates with the generative AI model through a predefined interface. In one embodiment, the generative AI model is a large-scale transformer-based language model deployed on the same server or on a separate computing device accessible through a network. The server transmits the prompt sentence and the associated text as a sequence of tokens to the generative AI model and receives generated tokens corresponding to summary information or explanatory text. The generative AI model internally uses an auto-regressive decoder architecture that calculates, for each output position, an attention-weighted combination of encoder states and previously generated tokens. The model has been trained in advance on large corpora by minimizing a cross-entropy loss between model outputs and ground-truth text, and the model parameters have been optimized by gradient-based methods such as stochastic gradient descent with adaptive learning rate. The server stores only the final trained parameters and does not perform training during inference.

The server estimates an emotional state based on acoustic characteristics of the audio information. The server uses an acoustic feature extraction module that computes low-level descriptors such as fundamental frequency, energy, zero-crossing rate, short-time spectral centroid, and mel-frequency cepstral coefficients for each audio frame by using digital signal processing operations. The server concatenates these features into a feature vector and forms a sequence of feature vectors for each utterance. The server inputs the feature vectors into an emotion classification network that includes one or more recurrent layers or temporal convolutional layers capable of modeling temporal dependencies. The emotion classification network outputs a probability distribution over a set of emotional categories. The server selects, for each utterance, an emotional state having a maximum probability as an acoustic emotion estimate and stores the probability values as confidence scores.

The server also estimates an emotional state based on linguistic content of the character information. The server uses a text-based emotion classifier, which in one embodiment is implemented as a transformer encoder followed by a pooling layer and a classification head. The server tokenizes the corrected character information, embeds the tokens, and computes sentence-level embeddings. The server then applies a softmax layer to obtain probabilities for emotional categories such as joy, sadness, anger, and neutrality. The server stores these probabilities as a linguistic emotion estimate for corresponding text segments.

The server integrates the acoustic emotion estimate and the linguistic emotion estimate to generate an emotion analysis result. The server aligns audio frames and text segments by using timestamps, and the server performs fusion at a frame level or at an utterance level. In one embodiment, the server applies a weighted averaging scheme in which acoustic and linguistic probabilities are linearly combined with weights that depend on a reliability measure such as confidence scores and signal-to-noise ratio. In another embodiment, the server uses a small fusion network that takes concatenated acoustic and linguistic feature vectors as input and outputs refined emotion probabilities. This multimodal fusion reduces misclassification caused by noise in a single modality and improves robustness.

The server detects an abnormal emotional change based on the emotion analysis result. The server constructs a time series of emotion probabilities for each participant and computes statistical descriptors such as derivatives, moving averages, and standard deviations. The server compares current emotion probabilities with historical baselines stored in a profile for the participant or with generic thresholds predetermined for each emotion. If the server detects a sudden change exceeding a threshold, such as a rapid increase in anger probability or a persistent negative emotional state over a specified duration, the server identifies this as an abnormal emotional change. The server then generates notification information, which may include textual descriptions such as “abrupt increase in anger level detected for participant A” and structured fields specifying type, time, and severity. The server may deliver the notification information to an administrator terminal or to a supervisory system.

The server recommends related information based on at least one of the emotion analysis result and the abnormal emotional change. The server accesses a recommendation database that maps emotional states and contexts to content identifiers. For example, in response to detection of fatigue, the server selects identifiers of relaxation audio, breathing exercise guidance, or short break suggestions. The server compiles a recommendation list including identifiers, titles, and summaries and outputs the recommendation list to the terminal. The server may also generate, through the generative AI model, a brief explanation of why the recommendation is made, by using a prompt sentence such as:

“Based on the user's reported feeling of fatigue and the following transcript, suggest suitable relaxing content and explain briefly why each item is appropriate.”

The server outputs at least part of the summary information, the normalized user input information, the emotion analysis result, the notification information, and the related information to the external apparatus. The external apparatus may be implemented by the terminal itself or by a display device or transaction processor separate from the terminal. The server formats output data in a representation that the external apparatus can interpret, including structured records for machine consumption and human-readable text for display.

The terminal controls the visual display apparatus based on information received from the server. When the terminal receives summary information and emotion analysis results related to a conference, the terminal renders a user interface that shows, in real time, key points of the discussion as generated summaries and visual indicators of current emotional states such as colored icons or graphs. When the terminal is a head-mounted display, the terminal overlays the summary information and emotional indicators onto a user's field of view so that the user can monitor the state of the conversation without diverting attention from the physical environment.

The server may include settlement information used for transaction processing in the normalized user input information. For example, when the user speaks or types payment-related information such as an address, account identifier, or amount, the server converts the audio information to character information, corrects and normalizes the content, and distinguishes structured fields such as street name, locality, and postal code. The server then constructs settlement information in a format required by an electronic transaction processing system. The server transmits the settlement information, together with auxiliary context such as a short description generated by the generative AI model, to the transaction processing system. The transaction processing system executes electronic transaction processing including validity checks, authorization requests, and posting of transaction records. The server receives the result of the electronic transaction processing and forwards a success or failure indication and any relevant details to the terminal. This arrangement prevents malformed or inconsistent data from being transmitted to the transaction processing system, thereby reducing transaction errors caused by speech recognition failures or user input mistakes.

The server improves computer technology itself in several respects. First, by performing grammatical and semantic correction and domain-specific normalization before generating prompt sentences and interacting with the generative AI model, the server reduces the effective input entropy for the generative AI model. As a result, the generative AI model can produce more accurate summaries with shorter sequences and lower computational cost, which improves processing speed and reduces resource consumption. Second, by fusing acoustic and linguistic features using a dedicated emotion fusion module and by maintaining explicit time-aligned data structures for emotion probabilities, the server prevents simple accumulation of errors from one modality and achieves higher emotion recognition accuracy than systems that rely solely on text-based sentiment or solely on acoustic features. Third, by detecting abnormal emotional changes and by generating notification information and recommendations in the server, the system shifts computational logic for monitoring and reaction from human decision-making to a reproducible algorithm that executes according to defined thresholds and patterns.

The server uses data structures designed to support these improvements. The server maintains, in the memory or storage, a session object that contains fields for raw audio buffers, transcription segments, corrected character information segments, summarization segments, acoustic feature sequences, emotion probability time series, and recommendation results. Each field is indexed by timestamps and speaker identifiers. This unified data structure allows the processor to access related information with reduced lookup overhead and to perform joint operations such as alignment and fusion with fewer memory accesses. This structure reduces latency compared with designs in which each module stores independent copies of temporal data.

The server may employ several training methods for the models used in the system. For the acoustic emotion classifier, the server uses labeled speech corpora comprising audio waveforms and emotion labels. The server extracts feature vectors, initializes a neural network having multiple hidden layers, and optimizes network weights by minimizing a loss function such as categorical cross-entropy on the emotion labels. The server applies regularization techniques such as dropout and batch normalization, and data augmentation techniques such as noise addition or time-stretching to improve generalization. For the text-based emotion classifier and the language correction model, the server uses pretraining on large unlabeled corpora by using masked language modeling objectives, followed by fine-tuning on smaller labeled datasets containing pairs of erroneous and corrected sentences or sentiment labels. The server employs mini-batch training and adaptive gradient methods to update weights. The trained parameters are then stored and used during inference.

The server applies decision criteria that are not simple human heuristics but are defined by mathematical relationships between probabilities, thresholds, and time-series statistics. For example, the server defines an abnormal emotional change when the first derivative of the anger probability exceeds a predetermined value and the absolute anger probability remains above a certain threshold for multiple consecutive segments. This precise definition enables consistent operation across deployments and is not dependent on subjective human judgments.

The user operates the terminal to initiate different usage modes of the system. In a conference support mode, the user starts an online conference, and the terminal automatically streams audio to the server. The user views, on the visual display apparatus, continuously updated summary information and emotion analysis results. In a payment mode, the user speaks or types address and payment information, and the user confirms normalized data and transaction results. In a support mode, the user may request, by natural language, a summary of a past conference by issuing a command such as “Write a summary of yesterday's meeting,” and the terminal sends this request to the server, which generates a prompt sentence for the generative AI model, retrieves corresponding transcripts, produces summary information, and returns the summary to the terminal.

In alternative embodiments, the server may integrate other types of generative AI models, such as encoder-decoder architectures or mixture-of-experts models, or may implement the generative AI model locally instead of calling an external service. The server may replace or augment the transformer-based emotion classifiers with convolutional networks or graph-based networks. The server may implement different fusion strategies, such as late fusion at the decision level or early fusion at the feature level. The terminal may be implemented as a vehicle infotainment system, an industrial terminal, or a wearable device. These variations still employ a processor configured to perform conversion of audio information to character information, grammatical and semantic correction, generation of prompt sentences, interaction with a generative AI model, multimodal emotion analysis, abnormal emotion detection, recommendation, and control of external apparatuses, so as to achieve improved accuracy, robustness, and computational efficiency of computer-implemented speech and text processing.

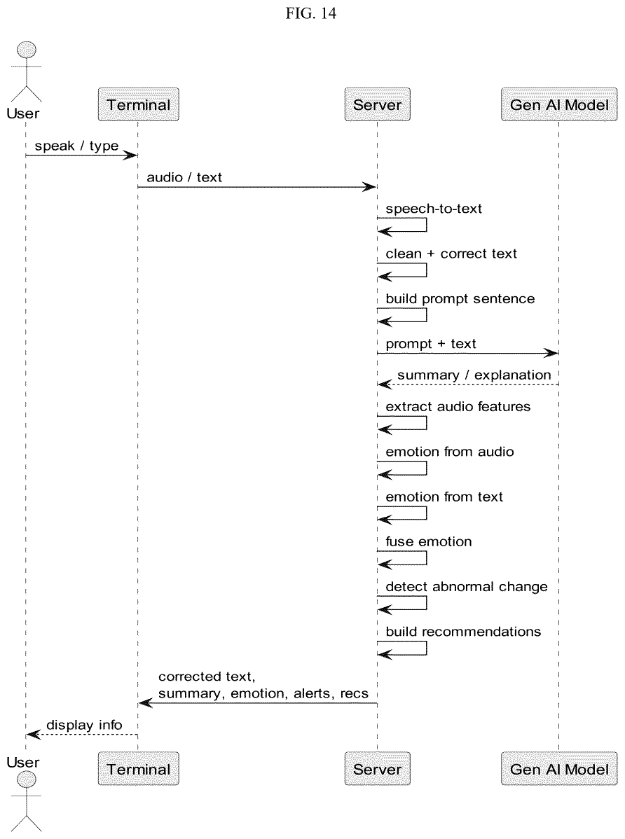

The following describes the processing flow using FIG. 14.
Step 1:

User provides speech or text input.

User speaks into a microphone of the terminal or types text into an input field on the terminal. The input is audio information (speech waveform) or raw text strings. The output is digitized audio frames or text events stored in the terminal memory and tagged with a session identifier and timestamps.
Step 2:

Terminal captures and transmits audio and text to the server.

Terminal uses an operating system audio driver to sample the audio information into digital audio frames (for example, 16-bit PCM at a fixed sampling rate) and segments the frames into fixed-length chunks. For text input, terminal collects each edit event from the input field. The input to this step is microphone signals and keypress events, and the output is a sequence of audio chunks and text payloads encapsulated with metadata (session ID, language code, timestamps) that the terminal transmits to the server via a network interface using a communication protocol.
Step 3:

Server receives and buffers session data.

Server receives the audio chunks and text payloads through a network interface and stores them in a session buffer in a main memory region and/or a persistent storage area. The input is network packets carrying audio and text data; the output is a structured session object including a list of audio segments, a list of raw text entries, and associated metadata. Server assigns internal identifiers to each segment to support later alignment.
Step 4:

Server performs speech-to-text conversion.

Server applies a speech recognition module to the buffered audio segments to convert audio information into character information. The input is an audio segment (sequence of samples) associated with a language setting; the server computes acoustic features and transmits the audio content to a speech-to-text engine using an interface. The output is transcription data containing recognized text, timing offsets, and confidence scores. Server stores the transcription data in a transcription table linked to the session object.
Step 5:

Server cleans and tokenizes the character information.

Server loads the transcription records and raw text entries and applies a natural language preprocessing module. The input is character information from the transcription table and any directly typed text; the server removes noise tokens, corrects spacing and punctuation, normalizes character types, and splits sentences into tokens by applying tokenization rules. The output is a cleaned and tokenized text representation stored as sequences of tokens with pointers back to the original text segments.
Step 6:

Server performs grammatical and semantic correction.

Server uses a transformer-based language correction model to refine the cleaned text. The input is a sequence of token identifiers representing the cleaned character information. The server feeds the token sequence into an encoder network that computes contextual embeddings, then applies a prediction head that outputs corrected token probabilities for each position. The server selects corrected tokens based on maximum probability or beam search, reconstructs corrected sentences, and applies domain-specific normalization rules. The output is corrected and normalized character information stored as a separate field in the session object.
Step 7:

Server constructs a prompt sentence for a generative AI model.

Server reads the corrected text and determines the processing context (for example, conference summarization, address correction, or emotion explanation). The input is corrected character information and a context indicator. Based on this input, the server generates a prompt sentence such as “Please summarize the following meeting transcript focusing on key decisions, action items, and deadlines:” or “Please normalize and correct the following address: Tokyo” and concatenates the relevant corrected text after the prompt sentence. The output is a full prompt string ready to be tokenized for the generative AI model.
Step 8:

Server sends the prompt sentence to a generative AI model and receives generated text.

Server converts the prompt sentence and the concatenated text into token identifiers and sends them to a generative AI model via an API or an internal interface. The input is the prompt string and associated encoded tokens; the generative AI model processes the sequence using an auto-regressive decoder to predict the next tokens until a termination condition is met. The server receives the generated tokens, decodes them into text, and obtains summary information or explanatory text. The output is generated text such as a meeting summary, a normalized address, or an explanation of detected emotion, stored in the session object.
Step 9:

Server extracts acoustic features from audio information.

Server accesses the raw audio segments stored in the session buffer and applies an acoustic feature extraction module. The input is audio sample arrays; the server computes features such as fundamental frequency, energy, spectral coefficients, and tempo by executing digital signal processing operations over sliding windows. The output is a time-aligned sequence of acoustic feature vectors, each tagged with a time index and segment ID.
Step 10:

Server estimates emotion from acoustic characteristics.

Server feeds the acoustic feature vectors into an emotion classification network. The input is a sequence of feature vectors per utterance; the network computes hidden representations through sequences of layers (for example, recurrent or temporal convolutional layers) and outputs emotion probability distributions for each time segment. The output is an acoustic emotion estimate that contains, for each frame or utterance, a set of emotion category probabilities and an assigned emotional state with maximum probability.
Step 11:

Server estimates emotion from linguistic content.

Server applies a text-based emotion classifier to the corrected character information. The input is the corrected text segments mapped to utterances; the server tokenizes the text, embeds the tokens, and aggregates token embeddings into sentence-level features by using an encoder and pooling operation. The server then applies a classification head to compute emotion category probabilities. The output is a linguistic emotion estimate containing emotion probabilities and labels for each text segment.
Step 12:

Server fuses acoustic and linguistic emotion estimates.

Server aligns acoustic emotion estimates and linguistic emotion estimates using their timestamps and segment IDs. The input is the acoustic emotion probability sequences and the linguistic emotion probability sequences. The server calculates combined probabilities by applying a weighted sum or a fusion network that takes both probability vectors as input. The output is an emotion analysis result that provides, for each time segment or utterance, a fused set of emotion probabilities and a final emotional state label with associated confidence.
Step 13:

Server detects abnormal emotional changes.

Server processes the emotion analysis result as a time series per participant. The input is a sequence of fused emotion probabilities ordered by time. The server computes temporal derivatives, moving averages, and deviations from baseline patterns. The server compares these computed values to thresholds stored in configuration data. When the server detects that a change in an emotion probability exceeds a defined threshold and persists for more than a specified duration, the server flags this as an abnormal emotional change and constructs notification information describing the event. The output is notification information objects containing type, time, affected participant, and severity.
Step 14:

Server generates recommendations based on emotion analysis and abnormalities.

Server reads the latest emotion analysis result and any abnormal emotion notifications. The input is fused emotion labels, confidence scores, and abnormality flags. The server queries a recommendation rule set or a recommendation database that maps emotional states and conditions to content identifiers and explanatory messages. Using this mapping, the server selects one or more related information items such as relaxation content or guidance messages. The output is a recommendation list including item identifiers, titles, and explanation text.
Step 15:

Server prepares response data for the external apparatus.

Server collects summary information from the generative AI model, normalized user input information, emotion analysis results, notification information, and recommendation lists for the current session. The input is the various processed data fields stored in the session object. The server formats these fields into a response structure that associates each piece of information with appropriate tags for display or machine use. The output is a response payload that the server transmits to the terminal or another external apparatus via the network interface.
Step 16:

Terminal updates the visual display based on server output.

Terminal receives the response payload and parses the contained data elements. The input is the response message from the server. The terminal updates display components, such as text fields for corrected input, panels for meeting summaries, charts or icons for emotional states, banners for abnormal emotion notifications, and lists or buttons for recommended content. The output is a rendered user interface on the visual display apparatus that presents the updated information in real time.
Step 17:

User reviews information and interacts with the system.

User observes the updated display on the terminal, including normalized text, summaries, emotion indicators, alerts, and recommendations. The input is the visual information presented on the display. Based on this information, the user may confirm or correct input data, adjust communication behavior, initiate or cancel a transaction, or select a recommended content item. The output is a new set of user actions (such as button presses, spoken commands, or additional input) that the terminal captures and passes back into the earlier steps of the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

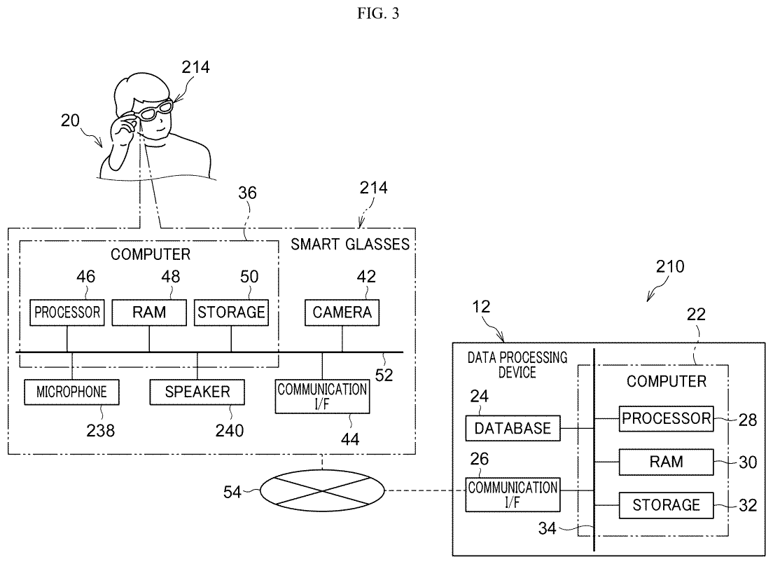

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

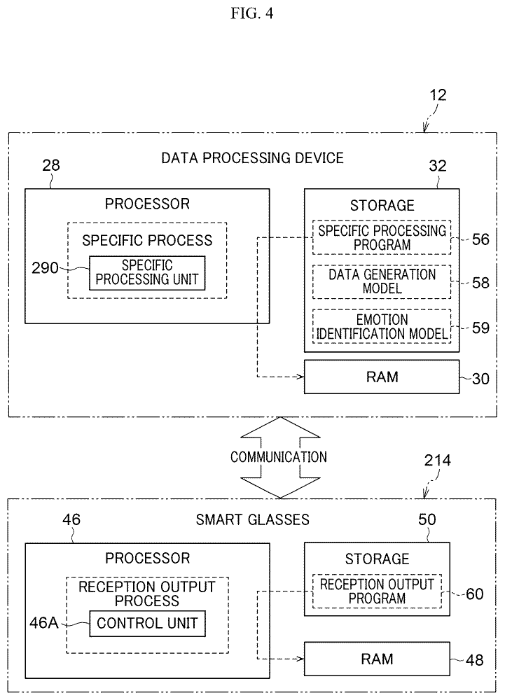

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

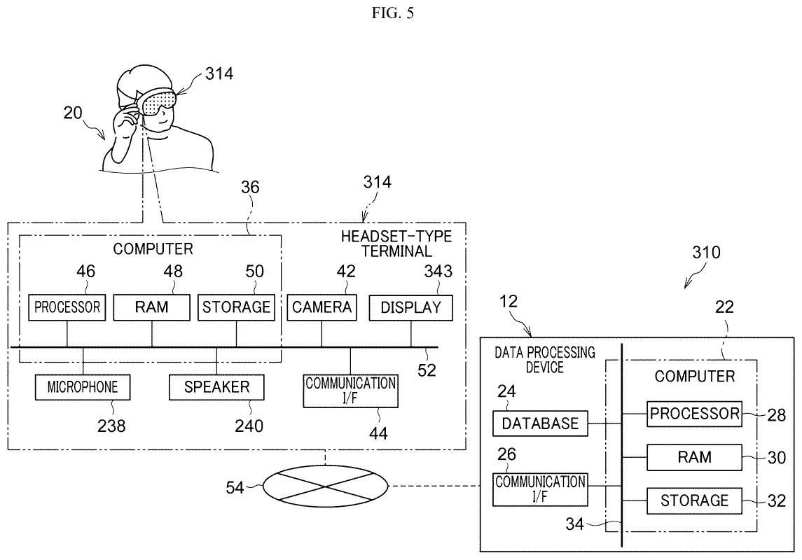

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

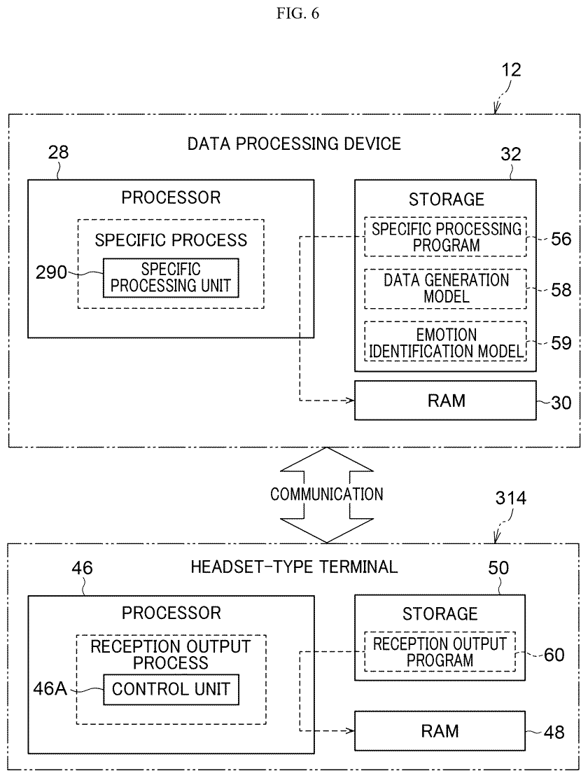

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

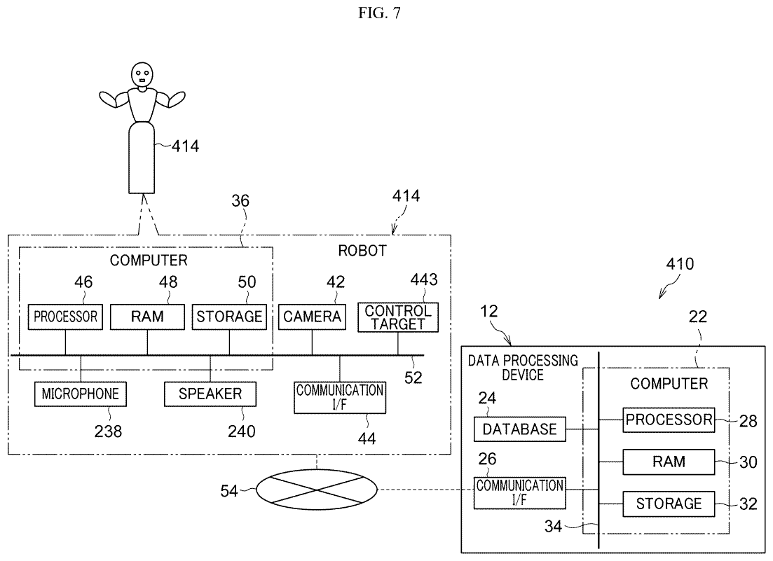

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

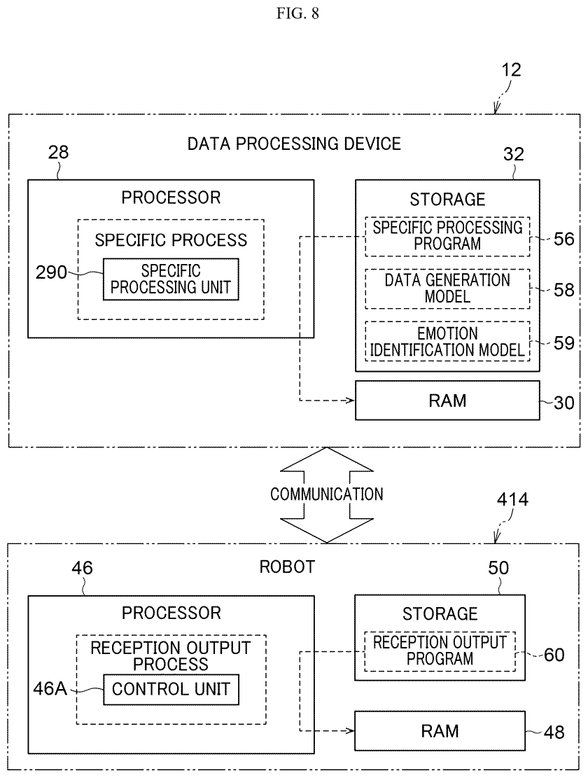

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

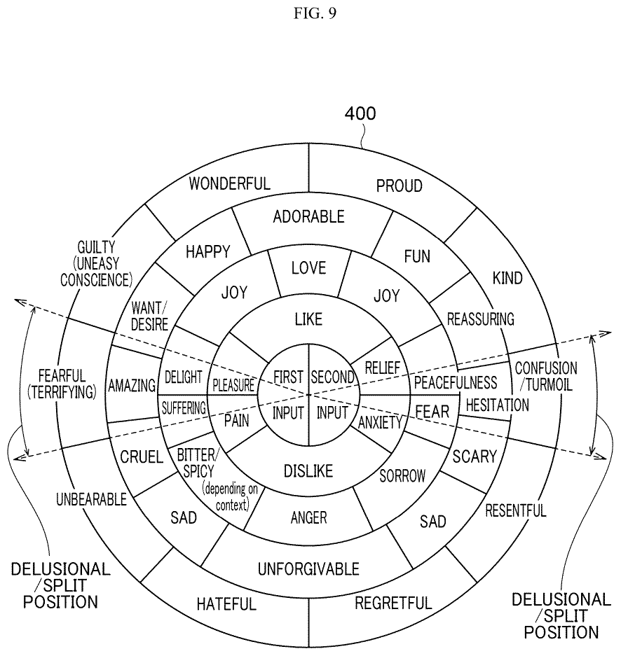

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

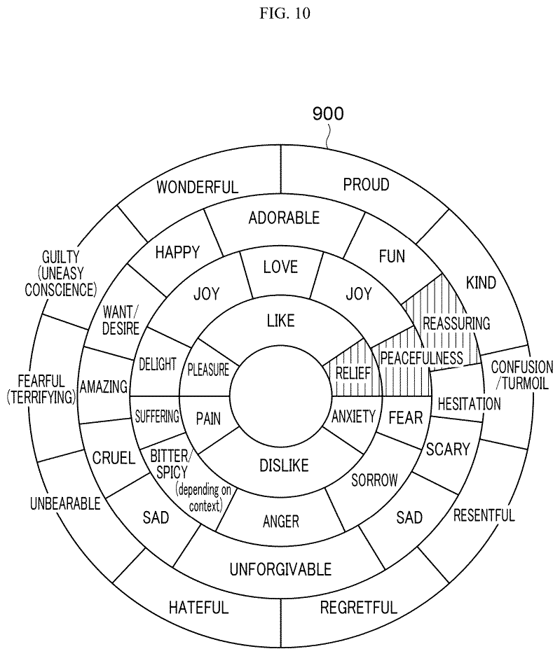

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive conference audio information from a communication terminal and convert the conference audio information into digital signals of a predetermined format for speech recognition processing,
transmit the predetermined-format digital signals to an external information processing apparatus for speech recognition processing to obtain character information corresponding to the conference audio information, and store the obtained character information in an information storage apparatus,
apply natural language processing based on a machine learning model to the character information stored in the information storage apparatus so as to perform grammatical and semantic correction, and construct corrected character information as input information for summarization,
generate, on the basis of the input information for summarization, a prompt sentence that defines content of a summary, an output format, and target information for extraction, and input the prompt sentence and the input information for summarization into a generative information processing model to cause the generative information processing model to generate summary information, and store the generated summary information in association with the information storage apparatus, and
search the character information and the summary information in the information storage apparatus on the basis of search conditions input by a user via a reception terminal, and output search results to the reception terminal.

### Supplementary 2

The system according to supplementary 1,
wherein the processor is configured to
analyze acoustic characteristics of the conference audio information and linguistic contents of the character information to recognize an emotional state, and include the recognized emotional state as additional information associated with the input information for summarization in the prompt sentence that is input to the generative information processing model.

### Supplementary 3

The system according to supplementary 1,
wherein the processor is configured to
evaluate, on the basis of the emotional state and the summary information, at least one of a progress degree of a conference, an activity level of discussion, and a degree of consensus formation, store an evaluation result as conference evaluation information in the information storage apparatus, and output the conference evaluation information to the reception terminal in association with the search results.

### Application Example 1

### Supplementary 1

A system comprising a processor,
wherein the processor is configured to
acquire audio information and transmit the audio information via a communication path, receive the transmitted audio information and convert the audio information into character information by performing speech recognition processing,
correct the character information grammatically and semantically by using a natural language processing technique implemented with a machine learning model,
generate a prompt sentence including conditions for summary generation on the basis of the corrected character information, and input the prompt sentence together with the corrected character information into a generative language model to cause the generative language model to generate summary information,
aggregate the generated summary information on a meeting unit basis or a time-interval unit basis, and input the aggregated summary information again into the generative language model to cause the generative language model to generate overall summary information, store the summary information and the overall summary information in association with time information of the audio information or the character information in a storage medium, and distribute the stored summary information or overall summary information to a terminal device via the communication path and cause the terminal device to display the summary information or the overall summary information.

### Supplementary 2

The system according to supplementary 1,
wherein the processor is configured to
include, in the prompt sentence input to the generative language model, summary generation conditions specifying at least one of a length of the summary, a format of the summary, and a type of target information for the summary.

### Supplementary 3

The system according to supplementary 1,
wherein the processor is configured to
evaluate a progress state of a meeting on the basis of the stored summary information or the stored overall summary information, and transmit an evaluation result to the terminal device for display.

### Example 2

### Supplementary 1

A system comprising a processor,
wherein the processor is configured to
acquire audio information and convert the audio information into character information, correct the character information grammatically and semantically and detect and correct errors in the character information by using natural language processing techniques including a machine learning model,
generate, based on corrected character information, a prompt sentence including summarization conditions, and input the prompt sentence and the corrected character information into a generative artificial intelligence model to generate summarized character information, and
transmit the character information, the corrected character information, and the summarized character information to an information terminal device via a communication network and cause the information terminal device to display the character information, the corrected character information, and the summarized character information.

### Supplementary 2

The system according to supplementary 1,
wherein the processor is configured to
receive, from the information terminal device, edit content by a user with respect to at least one of the corrected character information and the summarized character information, and, based on the edit content, update the summarization conditions and input an updated prompt sentence for regeneration into the generative artificial intelligence model to regenerate the summarized character information.

### Supplementary 3

The system according to supplementary 1,
wherein the processor is configured to
divide the audio information into a plurality of time units, sequentially generate the character information for each of the time units, apply the natural language processing techniques and the generative artificial intelligence model to the character information generated for each of the time units to incrementally update the corrected character information and the summarized character information, and sequentially transmit update results to the information terminal device.

### Application Example 2

### Supplementary 1

A system comprising a processor,
wherein the processor is configured to
acquire audio information and convert the audio information into character information, and correct the character information grammatically and semantically by using natural language processing technology so as to normalize user input information including erroneous input, and
generate a prompt sentence that instructs generation of a summary or an explanation based on the corrected character information or the normalized user input information, and input the prompt sentence and the character information into a generative AI model to generate summary information, and
estimate an emotional state based on acoustic characteristics of the audio information, and estimate an emotional state based on linguistic content of the character information and integrate the emotional state based on the linguistic content with the emotional state based on the acoustic characteristics to generate an emotion analysis result, and
detect an abnormal emotional change based on the emotion analysis result and generate notification information, and
recommend related information based on at least one of the emotion analysis result and the abnormal emotional change, and
output at least part of the summary information, the normalized user input information, the emotion analysis result, the notification information, and the related information to an external apparatus.

### Supplementary 2

The system according to supplementary 1,
wherein the processor is configured to
control a visual display apparatus as the external apparatus to sequentially display the summary information and the emotion analysis result during progress of a conference.

### Supplementary 3

The system according to supplementary 1,
wherein the processor is configured to
include settlement information used for transaction processing in the normalized user input information, execute electronic transaction processing based on the summary information and the normalized user input information, and output a result of the electronic transaction processing to the external apparatus.

What is claimed is:

1. A system comprising:
circuitry configured to:
receive, via a communication interface coupled to a packet-switched network, audio information from a terminal device, and convert the audio information into digital signals in a predetermined format;
transmit the digital signals to an information processing apparatus via the communication interface to perform speech recognition processing, obtain character information corresponding to the audio information, and store the character information in a storage device;
apply natural language processing based on a machine learning model to the character information to perform grammatical and semantic correction, and generate corrected character information as input information for summarization;
generate a prompt sentence that defines a content, an output format, and target information for extraction based on the corrected character information, and input the prompt sentence and the corrected character information into a generative neural network model to cause the generative neural network model to generate summary information; and
store the summary information in association with the character information in the storage device, and transmit the summary information to the terminal device via the communication interface.

2. The system according to claim 1, wherein the circuitry is configured to perform the grammatical and semantic correction by applying a machine learning model trained on text correction tasks to detect and correct misrecognitions, grammatical errors, and semantic inconsistencies in the character information.

3. The system according to claim 2, wherein the circuitry is configured to apply the machine learning model by tokenizing the character information, computing contextual embeddings using a transformer encoder, and decoding corrected token sequences using a language generation head.

4. The system according to claim 3, wherein the circuitry is configured to generate the prompt sentence by constructing a structured instruction that specifies summary length, output format, and information extraction targets, and concatenating the structured instruction with the corrected character information as model input data for the generative neural network model.

5. The system according to claim 1, wherein the circuitry is configured to aggregate generated summary information on a session unit basis or a time-interval unit basis, input the aggregated summary information into the generative neural network model with an overall summarization prompt to generate overall summary information, and store the overall summary information in association with time information of the audio information in the storage device.

6. The system according to claim 5, wherein the circuitry is configured to transmit the overall summary information to the terminal device via the communication interface for display in association with corresponding time intervals of the session.

7. The system according to claim 1, wherein the circuitry is configured to receive search conditions from the terminal device via the communication interface, search the character information and the summary information stored in the storage device based on the search conditions, and transmit search results to the terminal device.

8. The system according to claim 1, wherein the circuitry is configured to analyze acoustic characteristics of the audio information and linguistic content of the character information to recognize an emotional state of a speaker, and incorporate the recognized emotional state as additional context in the prompt sentence input to the generative neural network model.

9. The system according to claim 8, wherein the circuitry is configured to analyze the acoustic characteristics by extracting tone, volume, speech rate, and spectral features from the audio information using an acoustic feature analysis algorithm, and applying a trained emotion classification model to compute an emotional state label and an intensity value.

10. The system according to claim 9, wherein the circuitry is configured to evaluate, based on the recognized emotional state and the summary information, at least one of a progress degree of a session, an activity level of discussion, and a degree of consensus formation, store an evaluation result as session evaluation information in the storage device, and transmit the session evaluation information to the terminal device via the communication interface.

11. The system according to claim 10, wherein the circuitry is configured to compute the progress degree by applying a scoring function to the emotional state labels, intensity values, and temporal distribution of discussion turns recorded in the session, and output a progress score and an associated assessment.

12. The system according to claim 1, wherein the circuitry is configured to generate the prompt sentence with summary generation conditions specifying at least one of a length of the summary, a format of the summary, and a type of target information for extraction, and to selectively include or exclude speaker identification information in the summary based on the specified conditions.

13. The system according to claim 12, wherein the circuitry is configured to receive updated summary generation conditions from the terminal device during an active session, regenerate the prompt sentence with the updated conditions, and transmit updated summary information to the terminal device via the communication interface.

14. The system according to claim 1, wherein the circuitry is configured to store the summary information and associated character information in the storage device with time-stamp metadata, and enable retrieval of past session records by querying the storage device based on time range, speaker identifier, or keyword conditions received from the terminal device.

15. The system according to claim 14, wherein the circuitry is configured to perform a similarity-based search on stored summary information by computing embedding vectors for query text received from the terminal device, comparing the query embedding with stored summary embeddings using a cosine similarity metric, and returning ranked summary records as search results.

16. The system according to claim 1, wherein the circuitry is configured to distribute the summary information to a plurality of terminal devices associated with the same session via the communication interface, and to track distribution status for each terminal device in the storage device.

17. The system according to claim 16, wherein the circuitry is configured to monitor an acknowledgment signal from each terminal device indicating receipt of the summary information, and to re-transmit the summary information via the communication interface to terminal devices from which no acknowledgment is received within a timeout period.

18. A system comprising:
circuitry configured to:
receive, via a communication interface coupled to a packet-switched network, audio information from a terminal device, transmit the audio information to an information processing apparatus for speech recognition processing, and obtain character information;
apply natural language processing based on a machine learning model to the character information to perform grammatical and semantic correction, generating corrected character information;
generate a prompt sentence specifying summary content, output format, and information extraction targets, input the prompt sentence and the corrected character information into a generative neural network model to generate summary information, and aggregate the summary information on a session unit basis or a time-interval unit basis;
input aggregated summary information into the generative neural network model with an overall summarization prompt to generate overall summary information, and store the summary information and overall summary information in association with time information of the audio information in a storage device;
analyze acoustic characteristics and linguistic content of the audio information to recognize an emotional state of a speaker, and evaluate at least one of a progress degree, a discussion activity level, or a consensus degree of a session based on the recognized emotional state and the summary information; and
transmit the summary information and session evaluation information to the terminal device via the communication interface.

19. The system according to claim 18, wherein the circuitry is configured to perform a similarity-based search on stored summary information using embedding vectors for query text, comparing query embeddings against stored summary embeddings using a cosine similarity metric, and returning ranked results to the terminal device.

20. A method comprising:
receiving, via a communication interface coupled to a packet-switched network, audio information from a terminal device, and converting the audio information into digital signals in a predetermined format;
transmitting the digital signals to an information processing apparatus via the communication interface to perform speech recognition processing, obtaining character information, and storing the character information in a storage device;
applying natural language processing based on a machine learning model to the character information to perform grammatical and semantic correction, and generating corrected character information as input information for summarization;
generating a prompt sentence that defines a content, an output format, and target information for extraction based on the corrected character information, and inputting the prompt sentence and the corrected character information into a generative neural network model to cause the generative neural network model to generate summary information; and
storing the summary information in association with the character information in the storage device, and transmitting the summary information to the terminal device via the communication interface.
